(19) United States
(12) Patent Application Publication
(10) Pub. No.: US 2025/0189495 A1
(43) Pub. Date: Jun. 12, 2025

(54) METHOD FOR HIGH-THROUGHPUT LIQUID CHROMATOGRAPHY

(71) Applicants: REGENTS OF THE UNIVERSITY OF MICHIGAN, Ann Arbor, MI (US); ROWAN UNIVERSITY, Glassboro, NJ (US)

(72) Inventors: Robert Kennedy, Ann Arbor, MI (US); James Grinias, Glassboro, NJ (US); Deklin Parker, Glassboro, NJ (US); Samuel Foster, Glassboro, NJ (US); Yue Xin, Ann Arbor, MI (US); Devin Makey, Ann Arbor, MI (US); George Thomas Knecht, Ann Arbor, MI (US)

(21) Appl. No.: 18/974,273

(22) Filed: Dec. 9, 2024

Related U.S. Application Data
(60) Provisional application No. 63/607,873, filed on Dec. 8, 2023.

(51) Int. Cl. G01N 30/20; G01N 30/02; G01N 30/32

(52) U.S. Cl. CPC G01N 30/20; G01N 30/32; G01N 2030/027; G01N 2030/207; G01N 2030/328

(57) ABSTRACT

A method for introduction of a sample into a liquid chromatography column with improved speed and reduced time between injections can utilize a segmented sample array that segments samples between segmenting fluid plugs to allow for substantially simultaneous injection of samples from an injection valve and preparation for next sample loading into the injection valve.

### CROSS-REFERENCE TO RELATED APPLICATION

The benefit of priority to U.S. Provisional Patent Application No. 63/607,873 filed Dec. 8, 2023, is hereby claimed and the disclosure is incorporated herein by reference in its entirety.

### FIELD

The disclosure relates to a method for sample introduction into a liquid chromatography column, and more particularly to a sample introduction for high-throughput chemical separations.

### BACKGROUND

High-throughput screening (HTS) approaches that can analyze large numbers (>104) of samples in a day are revolutionizing modern drug discovery, reaction discovery and optimization, diagnostics, sensing, and enzyme engineering. HTS experiments are typically executed in multi-well plates using liquid handling and plate manipulation performed by robots to quickly determine the highest-performing reagents, solvents, and catalysts. Detection of “hits” (e.g., highest activity or percent yield) is frequently performed using fluorescence or ultraviolet (UV) absorbance due to high throughput and sensitivity. However, these detection methods pose several limitations. For example, it is not always feasible for analytes to contain a fluorescent reporter. While absorbance detection has broader applicability compared to fluorescence, interference makes detection challenging when performed in complex matrices, such as those containing growth media, reaction components, and cell by-products.

High performance liquid chromatography (. Liquid chromatography is a flexible and sensitive approach that is commonly used in screening experiments where complex sample matrices make detection difficult. Typical gradient LC methods can be performed at rates of 1-5 min per sample, which allows for hundreds of samples to be processed overnight. However, even short, 1-min LC methods are infeasible for screening experiments that require thousands of samples be processed in a short period of time, such as during the directed evolution of enzymes. Fast isocratic LC separations on the order of 1-10 s using short columns packed with superficially porous particles started to be reported nearly a decade ago.

Despite the ability to perform these fast LC separations, they have never been utilized for HTS due to limitations in autosampler cycle time. Multiple injections in a single experimental run (MISER) chromatography, a variant on flow injection analysis where samples are sequentially injected onto an analytical column during the same chromatographic run, has been used to increase the throughput of LC analysis. Separation times of 1-15 s have appealing applications in a variety of high-throughput experiments, such as screening organic reactions, biocatalyst development, chemical “sensing”, process monitoring, and quality test of chemical libraries among others. A second limitation has been the use of larger bore columns, necessitating flow rates in the 5-8 mL/min range for fast separations. Such flow rates would generate substantial amounts of mobile phase waste for large scale screens. Further they hinder interface to mass spectrometry detection. The fastest application of MISER was for HTS of enzyme variants, where the analysis of 96 reactions was possible in 17 min using a dual needle autosampler with an 11 s injection cycle time. Currently, the fastest autosampler has a cycle time of 7 s when using overlapped injection mode (which limits applications to isocratic separations); however, most autosamplers take >30 s to perform an injection. Even when using the fastest commercially available autosampler for high-throughput LC, only 15% of the cycle time would be used for separation with a 1 s method. High-throughput experimentation (HTE) workflows commonly utilize 96, 384, or 1536 reactions in a single investigation, and the analysis of these samples can lead to significant bottlenecks in research and development. When fast turnaround is crucial, the analysis throughput limits the breadth of chemical space that can be explored during HTE. Therefore, reducing autosampler cycle time would allow for more samples to be processed using sub-second LC methods and enable more efficient analysis of samples generated in HTE workflows.

### SUMMARY

Methods of the disclosure provide a high-throughput droplet microfluidic injection approach with capillary LC. Methods of the disclosure have been demonstrated to be applicable to screening organic and enzymatic reactions.

In accordance with the disclosure, a method for introduction of a sample into a liquid chromatography column having an injection valve comprising a sample inlet, a sample outlet, a waste outlet, a first subset of fluidically coupled ports fluidically coupled by a sample loop, and a second set of fluidically coupled ports can include providing a sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible. The method further includes actuating the injection valve to a first position, wherein in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet; and flowing a first sample plug into the sample loop while the injection valve is in the first position until a portion of the first sample plug flows out of the waste outlet indicating the sample loop is filled. The method then includes actuating the injection valve to a second position after the sample loop is filled. In the second position: the port of the first subset of ports at the outlet of the sample loop is fluidically coupled to the sample outlet, and the second subset of ports is arranged to fluidically couple the sample inlet and the waste outlet. The method includes flowing the first sample plug contained in the sample loop into the liquid chromatography column through the sample outlet while the injection valve is in the second position; flowing a first segmenting fluid plug through the sample inlet and out the waste outlet while the injection valve is in the second position; and repeating actuating of the injection valve to the first position, flowing of a sample plug into the sample loop, actuating of the injection valve to the second position, flowing of a sample plug into the liquid chromatography column through the sample outlet, and flowing of the segmenting fluid to waste outlet for each subsequent sample plug and segmenting fluid plug.

In accordance with the disclosure, a method for introduction of a sample into a liquid chromatography column comprising an injection valve comprising a sample inlet, a sample outlet, a waste outlet, a first subset of fluidically coupled ports fluidically coupled by a sample loop, a second set of fluidically coupled ports, and an opaque region defined by a connector fluidically coupling the sample inlet and the sample loop can include flowing a sample array into the sample inlet, the sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible, and each of the plurality of sample plugs and the plurality of segmenting fluid plugs having a length in the sample inlet that is greater than a length of the opaque. The method further includes obtaining images of a region of the sample inlet, wherein a sample plug present in the sample inlet is distinguishable from a segmenting fluid plug present in the inlet tubing by a gray value in the images. For each image, the method includes measuring a gray value and comparing the gray value of the image to a sample plug threshold gray value and a segmenting fluid plug threshold gray value to determine presence of a sample phase or segmenting fluid phase in the image, wherein a phase in the image is a sample plug phase when the gray value of the image is lower than the sample plug threshold gray value and is a segmenting fluid phase when the gray value of the image is higher than the segmenting fluid threshold gray scale value. For each image, the method includes comparing the image with a previously taken image to determine if a phase in the image has changed relative to the previously taken image. The injection valve is actuated to a first, load position, when a phase change from the segmenting fluid phase in the previously image to the sample fluid phase is detected, wherein in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet, and in the first position, a sample plug is flowed into the sample loop from the sample inlet and flows out of the waste outlet when the sample loop is filled with the sample plug. The injection valve is actuated to a second, inject, position when a phase change from the sample fluid phase in the previously image to the segmenting fluid phase is detected, wherein in the second position, the port of the first subset of ports at the outlet of the sample loop is fluidically coupled to the sample outlet, the second subset of ports is arranged to fluidically couple the sample inlet and the waste outlet, and the sample plug contained in the sample loop is flowed into the liquid chromatography column through the sample outlet while the injection valve is in the second position, and the segmenting fluid plug through the sample inlet and out the waste outlet while the injection valve is in the second position. Actuation of the injection valve is repeated between the first and second position when phase changes in the images are detected.

In accordance with the disclosure, a method for introduction of a sample into a liquid chromatography column comprising an injection valve comprising a sample inlet, a sample outlet, a waste outlet, a first subset of fluidically coupled ports fluidically coupled by a sample loop, a second set of fluidically coupled ports, an opaque region defined by a connector fluidically coupling the sample inlet and the sample loop, can include flowing a sample array into the sample inlet, the sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible, and each of the plurality of sample plugs and the plurality of segmenting fluid plugs having a length in the sample inlet that is less than a length of the opaque. The method includes obtaining images of first and second regions of sample inlet while each of the plurality of sample plugs and segmenting fluid plugs is flowed through the sample inlet, wherein the first region is immediately upstream of the opaque region, and the second region is at least a selected distance upstream of the first region. The method further includes determining a phase of each image by measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value. An arrival time for each of the plurality of sample plugs and plurality of segmenting fluid plugs is calculated by: determining whether a phase of the sample inlet at the second region is a segmenting fluid plug phase or a sample plug phase to thereby determine whether the calculated arrival time is for a sample plug or a segmenting fluid plug; measuring a time of arrival of a head of the sample plug or segmenting fluid plug in each image at the second region, wherein the head of the sample plug or segmenting fluid plug is determined by detecting an interface between the sample plug phase and a segmenting plug phase in the image at the second region; measuring a time of arrive of the head of the sample plug or the segmenting fluid plug at the first region, wherein the head of the sample plug or the segmenting fluid plug is determined by detecting the interface between the sample plug phase and the segmenting plug phase at the first region; determining a difference of arrival time of the head of the sample plug or the segmenting fluid plug between the second region to the first region; calculating a velocity of the sample plug and the segmenting fluid plug by dividing the distance between the first and second regions by the respective difference of arrival time; and calculating an arrival time of the sample plug or the segmenting fluid plug at the sample loop by dividing a length of the opaque region by the respective calculated velocity and adding the quotient to a current time to thereby give the arrival time of the sample plug or the segmenting fluid plug. An array of arrival times of each of the plurality sample plugs and the plurality of segmenting fluid plugs is generated. The injection valve is actuated between the first, load position and the second, inject position by comparing a current time to the array of arrival times. The injection valve is actuated to the first, load position when the current time is equal to an arrival time of a sample plug; and the injection valve is actuated to the second, inject position when the current time is equal to an arrival time of a segmenting fluid plug. In the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet, and in the first position, a sample plug is flowed into the sample loop from the sample inlet and flows out of the waste outlet when the sample loop is filled with the sample plug, and in the second position, the port of the first subset of ports at the outlet of the sample loop is fluidically coupled to the sample outlet, the second subset of ports is arranged to fluidically couple the sample inlet and the waste outlet, and the sample plug contained in the sample loop is flowed into the liquid chromatography column through the sample outlet while the injection valve is in the second position, and the segmenting fluid plug through the sample inlet and out the waste outlet while the injection valve is in the second position.

### BRIEF DESCRIPTION OF THE DRAWINGS

FIGS. 1A to 1E show an overview of high-throughput LC using a segmented flow injector. Droplets are formed in a capillary tube from a multi-well plate using a syringe pump in withdrawal mode (A). Air was used as the segmenting fluid between individual sample plugs. The resulting train of samples was infused into a standard six-port injection valve using a syringe pump in infusion mode. Once a droplet had filled the sample loop (B), the valve was switched to the second (inject) position (C). The valve was immediately switched back to the first position so the next sample plug could fill the loop while the previous sample eluted from the column (D). The process was repeated for the remaining sample plugs and discrete separations were observed for each injection (E).

FIG. 2A to 2D are graphs showing high-throughput LC analysis of standard three-component mixtures. 96 droplets containing a mixture of thiourea, acetophenone, and propiophenone were generated from a well plate, infused into the valve, and injected every A) 1.6 s and B) 1.0 s. Injections were highly repeatable, as the RSDs of peak area measurements were between 0.5-1.0% in panel A and 1.1-1.2% in panel B. The same mixture of thiourea, acetophenone, and propiophenone was diluted at four levels and deposited into a well plate. 96 droplets with varying analyte concentrations were generated from the plate, infused into the valve, and injected every C) 1.6 s and D) 1.0 s. The mobile phase was 35/65 ACN/H₂O with 0.1% FA at 3 mL/min in panels A and C and 40/60 ACN/H₂O with 0.1% FA at 5 mL/min in panels B and D. The column temperature was 70° C. Detection was performed by monitoring absorbance at 254 nm.

FIG. 3A to 3F are graphs assessing sample carryover. A) Alternating injections of a mixture of thiourea, propiophenone, and acetophenone and an H₂O blank. B) Zoomed in view of panel A. C) Alternating injections of a mixture of thiourea, propiophenone, and acetophenone, with an ACN wash droplet (not injected) when an ACN wash droplet was placed between each sample or blank. D) Alternating injections of a mixture of acetaminophen, caffeine, and acetylsalicylic acid and an H₂O blank. E) Zoomed in view of panel D. F) Alternating injections of a mixture of acetaminophen, caffeine, and acetylsalicylic acid when an ACN wash droplet was placed in between each sample or blank. Timing of sample injections, blank injections, and wash droplets was as follows: S, Sample injection; B, H₂O blank injection; W, ACN wash (no injection). Detection was performed by monitoring absorbance at 210 nm for panels A-C and 254 nm for panels D-F.

FIGS. 4A to 4E are graphs showing the screening of inhibitors of cytochrome P450-catalyzed bentazon hydroxylation. A) Total ion chromatogram showing signals resulting from the screening experiment. B) 10-point calibration curves for bentazon and 6-hydroxybentazon ranging from 0.1-50 UM in concentration. C) Correlation between concentrations measured using fast (6 s per sample) and conventional (3 min per sample) LC. D) Extracted ion chromatograms demonstrating the inhibition of bentazon hydroxylation in the presence of inhibitor A at concentrations indicated in blue. E) Comparing the inhibitory activity of four inhibitors determined using fast and conventional LC. Conditions for fast LC were as follows: Mobile phase, 25/75 ACN/H₂O with 0.1% FA; Flow rate, 1.5 mL/min; Column temperature, 50° C. Conditions for conventional LC: Mobile phase A, H₂O with 0.1% FA; Mobile phase B, ACN with 0.1% FA; Solvent gradient, 5-50-90-90-5-5% B from 0-1-1.01-1.5-1.51-2 min; Flow rate, 1.5 mL/min; Column temperature, 50° C.; Detection, multiple reaction monitoring.

FIGS. 5A to 5E graphs showing fast LC separations of thiourea, acetophenone, and propiophenone. A) The starting chromatographic conditions were as follows: Column, Poroshell Stablebond C18 (2.1 mm i.d.×5 mm length, 2.7 μm); Flow rate, 3 mL/min; Mobile phase, 30/70 ACN/H₂O with 0.1% FA. B) Separation using the same conditions as in panel A, except the pre-column heater and column oven were set to 50° C. C) Separation using the same conditions as in panel B, except the mobile phase was 35/65 ACN/H₂O with 0.1% FA. D) Separation using the same conditions as in panel C, except the pre-column heater and column oven were set to 70° C. E) Separation using the same conditions were used as in panel D, except the flow rate was 5 mL/min. Detection was performed by monitoring absorbance at 210 nm.

FIGS. 6A and B are graphs showing the repeatability of 96 injections of continuous sample. A mixture of thiourea, acetophenone, and propiophenone was continuously infused into the valve and injected 96 times at A) 2.0 s per injection and B) 1.0 s per injection. The flow rate was 3 mL/min in panel A and 5 mL/min in panel B. The mobile phase was 35/65 ACN/H₂O with 0.1% FA. The column temperature was 70° C. Detection was performed by monitoring absorbance at 254 nm.

FIG. 7 is a graph showing the impact of injector timing on peak shape. The fourth injection took place as the last peak from the third injection reached the detector, which resulted in a shouldering peak (red arrow). The sample was a mixture of thiourea, acetophenone, and propiophenone. The mobile phase was 35/65 ACN/H₂O with 0.1% FA at 3 mL/min. The column temperature was 70° C. Detection was performed by monitoring absorbance at 254 nm.

FIG. 8 is a graph showing separation of bentazon and 6-hydroxybentazon using a 3 s method. A total ion chromatogram showing the 3 s separation of bentazon and 6-hydroxybentazon in P450 reaction matrix. The separation conditions were as follows: Mobile phase, 35/65 ACN/H₂O with 0.1% FA; Flow rate, 1.5 mL/min; Column temperature, 50° C.; Detection, multiple reaction monitoring.

FIG. 9 is a graph showing the impact of ion suppression on 6-hydroxybentazon quantitation. Unretained matrix components coeluted with 6-hydroxybentazon when using a 3 s LC method. The separation conditions were as follows: Mobile phase, 35/65 ACN/H₂O with 0.1% FA; Flow rate, 1.5 mL/min; Column temperature, 50° C.; Detection, multiple reaction monitoring.

FIG. 10 is a schematic illustration of sample generation and separation. a) The valve is at the loading position, the droplet samples are drawn from the well plate and segmented by perfluorodecalin oil (yellow) in the PFA tubing by sampling alternately from PDF and sample wells. and sent to the internal sample groove in the valve. b) The valve is at the injection mode. The internal sample groove loaded with a sample is sent to the left side for separation.

FIGS. 11A and 11B are graphs showing the effect of flow rate and column to detector tubing dimensions on LC separation of 3 component test mixture. a) Different flow rates tested on the same column (Luna) with the same mobile phase (premixed 35/65 acetonitrile/water+0.1% TFA) for standard sample mixture of thiourea, 2,5-dihydroxybenzoic acid, and phenylacetic acid. Chromatograms are normalized. b) Effect of changing inner diameter of column to detector tubing. 10.2 cm length fused silica capillaries of a series of inner were installed and tested for the standard samples with the same column and mobile phase as a). Flow rate was 70 μL/min except for the 25 μm i.d. capillary which ran at 60 μL/min giving back pressure of 4.8 k psi, which was just below the pressure limit 5 k psi of the column.

FIGS. 12A to 12F are graphs showing high throughput separation tests with 4-second cycle time. A) 96 injections of samples infused in a continuous flow from the syringe. B) Zoomed-in of 6 separations from a. C) Normalized first, middle, and last separations in a. D) 96 injections of samples drawn from the well plate as segmented droplets of alternating concentrations. E) Zoomed-in view of 6 separations from c. F) Normalized first, middle, and last separations in c. For both experiments, the mobile phase was premixed 35/65 acetonitrile and water+0.1% TFA. Flow rate was 70 μL/min. The analytes were thiourea, 2,5-dihydroxybenzoic acid, and phenylacetic acid dissolved in aqueous solutions with 20% acetonitrile. The wavelength for UV detection was 214 nm.

FIGS. 13A and 13B are graphs showing the evaluation of carryover and its elimination. (A) Top: duplicate injections of one sample containing 16 mM thiourea, acetophenone, and propiophenone followed by 5 blank droplets. Only the first blank has carryover signals. Bottom: zoomed-in view of intensity between 0 to 0.1 V. (B) Top: duplicate injections of one sample and one blank droplet with a 10 nL uninjected wash droplet (100% acetonitrile) in between. The carryover of thiourea, acetophenone, and propiophenone was reduced to 0, 2.3%, and 7.8%, respectively, calculated from the peak heights. Bottom: zoomed-in view of intensity between 0 to 0.1 V.

FIGS. 14A and 14B are graphs showing a screen of 96 reactions with an injection method in accordance with the disclosure showing A) LC-MS extracted ion chromatograms (EIC) for reactants and products of the reaction screen. Trace shows all 96 reactions screened. Insets show an expanded view of selected reactions. EIC legends show the m/z of compound for each colored EIC trace. B) The percentage of elimination products over the total converted products increases as the percentage of methanol or water in the solvents increases. The dots are individual data points, and the line is the averaged value of the duplicates for each condition.

FIG. 14C is a map of reactions deposited on the well plate. Darker color indicates higher yield of imines.

FIG. 15 shows images of a sample inlet taken for automatic injection valve actuation based on the convex or concave nature of the sample droplet.

FIG. 16 is a schematic illustration of a system for automatic actuation of an injection valve for methods in accordance with the disclosure.

FIG. 17 is a graph showing a sequence of 20 nL sections injected from 60 nL droplets using automatic injection in accordance with the disclosure.

### DETAILED DESCRIPTION

Methods in accordance with the disclosure provide for improved speed of loading of samples into a liquid chromatography (LC) machine, which can significantly reduce the overall time needed for high-throughput screening processes. Methods of the disclosure can reduce the injection time of a sample to time scales of even the fastest HPLC separation processes and can be used down to capillary scale liquid chromatography. Methods in accordance with the disclosure use sample introduction by droplet microfluidics to address the cycle time limitations of current autosamplers. The terms “plug” and “droplet” are interchangeably used herein to refer to discrete volumes of a particular component, such as sample, segmenting fluid, or washing fluid.

Methods of the disclosure utilize an injection valve that is fluidically coupled to the inlet of an LC column. The injection valve can include a sample inlet, a waste outlet, and a sample outlet. The injection valve can further include a mobile phase inlet for flowing the sample through the sample loop and out the sample outlet. The sample array is loaded into the injection valve through the sample inlet sequentially, and each sample is injected into the LC column through the sample outlet.

The injection valve further includes a plurality of ports, with at least two subsets of the plurality of ports, each subset of ports being fluidically coupled. A first subset of the ports is fluidically coupled by a sample loop. The injection valve is capable of actuating between first and second positions. The first position is a sample loading position in which the sample loop is filled with a sample plug and the second position is a sample injection position in which sample plug is injected into the LC column. In the first position, the first subset of the plurality of ports fluidically coupled by the sample loop is positioned such that the port at the inlet of the sample loop is aligned with the sample inlet and the port at the sample loop outlet is aligned with the waste outlet. In the first position, if the injection valve includes a mobile phase inlet, the second subset of fluidically couple ports can be positioned to be aligned with the mobile phase inlet and the sample outlet for flow of mobile phase into the LC column. In the second position, the first subset of fluidically coupled parts is positioned such that the sample plug contained in the sample loop can be flowed out the sample outlet and into the LC column. For example, if the system includes a mobile phase inlet, the first subset of ports are positioned such that the port at the inlet of the sample loop is aligned with the mobile phase inlet and the port at the outlet of the sample loop is aligned with the sample outlet, such that mobile phase is flowed into the sample loop to force the sample plug present in the sample loop out of the sample loop and through the sample outlet to be loaded into the LC column. In the second position, the second subset of ports is aligned such that a port is aligned at the sample inlet and another port is aligned at the waste outlet, and a segmenting fluid is flowed through the second subset of fluidically coupled ports and directed from the sample inlet to the waste outlet.

Methods of the disclosure include providing a sample array comprising a plurality of sample plugs and a plurality of segmenting fluid plugs, adjacent ones of sample plugs being separated by a segmenting fluid plug, with each sample plug comprising a sample to be analyzed. The method further includes filling the sample loop with a first sample plug while the injection valve is in the first position. Filling of the sample loop can include flowing sample through the sample inlet into the sample loop until a portion of the sample flows out the waste outlet. The waste outlet or a connecting thereto can be monitored, for example, by a detection device for detection of the sample exiting the sample loop. The detection device can be, for example a camera. The detection device can be connected to an actuator for the valve, for example, to automatically actuate the valve to the second position once the sample plug is detected to be existing the sample loop. Any known detection devices, control systems, actuators, automation systems, and the like can be used for the detection and automatic actuation of the valve.

Once the sample loop is filled, the injection valve is actuated to the second position and the sample plug present in the sample loop is flowed into the LC column through the sample outlet. While in the second position, the segmenting fluid plug is introduced into the sample inlet and is directed and flowed out of the waste outlet through the second set of fluidically coupled ports. The flowing of the sample from the sample loop into the LC column and the flowing of the segmenting fluid through the second subset of fluidically coupled ports can occur substantially simultaneously or simultaneously. The process is then repeated for the second and subsequent sample plugs, by actuating the injection port back to the first position for the loading of the sample loop with a sample plug.

In any of the methods described herein, the sample array can be prepared in a container before connecting to the injection valve for sample introduction. The container can be, for example, a tube. For example, PTFE tubing. Droplets or plugs of sample and segmenting fluid can be alternatingly drawn into the container using any known methods. Methods of the disclosure can alternatively include formation of the sample array substantially simultaneously with the sample loop filling and LC column loading. For example, the sample inlet of the injection valve can be coupled to a sampling tube. The sampling tube can be alternatingly moved into containers containing samples (such as vials or well plates) and segmenting fluid to generate the sample array. Movement of the sampling tube can be coordinate with the actuation of the injection valve between the first position, at which the sampling tube would be positioned in a sample for sample loop filling with a sample plug, and the second position, at which the sampling tube would be positioned in the segmenting fluid for flowing a segmenting fluid plug through the second subset of fluidically couple ports to the waste outlet. Movement of the sampling tube inlet can be achieved automatically with known actuation equipment. The samples and segmenting fluid can be contained, for example, in a well-plate. The sample array may also be generated from microfluidic devices e.g., a fluidic tee that uses the segmenting fluid to break a stream of immiscible sample fluid into a series of plugs.

In any of the methods of the disclosure, the segmenting fluid can be any fluid that is immiscible or has limited miscibility with the sample. For example, the segmenting fluid can be air. For example, the segmenting fluid can be an oil. For example, the oil can be a fluorinated liquid such as perfluorodecalin.

The sample array, whether formed before the injection process or during the injection process can further include a washing plug arranged immediately upstream of each sample. The washing plug can include a washing fluid, such as acetonitrile, methanol, isopropanol, or any fluid that is found to prevent carryover. The washing plug can be flowed through the sample loop during the filling process, before the sample is flowed into the sample loop to aid in reducing or preventing carryover between samples.

The volume of the sample plugs can be selected based on the amount of sample needed for screening and the sample loop size. For example, the volume of the sample plug can be about 1.5× to about 4× the volume of the sample loop.

Methods of the disclosure can be used for sample injection into any known liquid chromatography columns, such as HPLC columns and capillary LC columns. Use of the methods of the disclosure with capillary LC columns can provide for not only significantly faster injection and sampling times as compared to conventional autosamplers, with significantly reduced mobile phase as compared to standard HPLC columns. For example, assuming, mobile phase flow rate of 70 μL/min, and a 4 s separation time, the total consumption of mobile phase would be 47 mL and analysis time would be just 11 h for a 10,000 sample experiment. In comparison, if the same experiment was run on a typical LC system with an autosampler and a relatively large bore column which, for example, uses a 15 s autosampler sequence and completes separation in 1 s at flow rate of 8 mL/min, would require 21000 mL of mobile phase and 44 h. According to this calculation, methods in accordance with the disclosure can save hundreds of folds in mobile phase and can complete the process in 1/4 of the time. Therefore, the method of the disclosure in a fast capillary LC system has a great potential in achieving high throughput in a greener and more time efficient way than HPLC. The system also reduces sample consumption, requiring for example, sample amounts of about 50 to about 300 nL for each assay.

The use of a capillary LC can also facilitate interface to MS. The typical operational flow rate of the fast capillary LC system falls within the range of 20-90 μL/min, making it compatible with the electrospray ionization source in mass spectrometry without modifications such as split flow. The use of a capillary LC can also facilitate the ability to continuously inject from a well plate rather than using a two-step process of loading samples into a capillary tube that is then pumped into the injector. Such capability not only simplifies automation of the injector but makes true high-throughput experiments more feasible e.g., by coupling the system to a plate handling robot for multiple plates.

The method is designed to avoid the segmenting fluid plugs from entering the liquid chromatography column, but errors in injection occur and segmenting fluid can unintentionally enter the column. Entry of the segmenting fluid, particularly, oil, can be detrimental to the separation performed in the LC column. If oil happens to enter the LC column, it has been surprisingly and beneficially observed that the LC column can be regenerated by flowing an organic solvent, such as acetonitrile through the column. For example, a method of regenerating a column contaminated by a segmenting oil can include contamination of the column by introduction of the segmenting oil into the column, and flowing of an organic solvent through the column to regenerate the column after the contamination. The segmenting oil can be a fluorinated oil, such as perfluorodecalin. The organic solvent can be, for example, acetonitrile. The organic solvent can be flowed into the column in a volume equal to or greater than at least one column volume. Larger volumes are also contemplated herein. It is contemplated herein that in the methods of regeneration, the step of contaminating the column can result from an injection error or other error. Contamination of the column with the segmenting fluid is contemplated as an active step occurring in the method of the disclosure though unintentional and through error, for example, of the injection system. Segmenting oils, such as fluorinated oils, are not generally introduced into an HPLC column intentionally, as they would be detrimental to the column performance. In methods of the disclosure in which the sample array is prepared substantially simultaneously with the injection process, the regeneration method can be accomplished by simply arranging the sampling tube in a container of organic solvent and flowing the washing fluid into the LC column for the needed duration of time for regeneration. Alternatively, the mobile phase inlet, if present, can be used for flowing the mobile phase into the LC column for cleaning/regeneration.

In any of the methods of the disclosure, actuation of the injection valve can be automated and controlled by a controller. The controller can receive signals from a detection device, such as a camera, and based on the received signal control a valve controller electronically coupled to the injection valve to actuate the injection valve. Electronic coupling and communication between controllers and actuation devices as known in the art can be used herein. Systems for automatic control of the valve can include, for example, a processor separate from or a part of the detection device. For example, a camera or other detection device can be focused on the sample inlet for detection of the presence of a sample plug or segmenting plug in the sample inlet, actuation of the injection valve between the first (load) position and the second (inject) position can be controlled, for example, based on what type of plug (sample or segmenting fluid) is present in the sample inlet or anticipated to arrive at the sample loop next. Any camera can be used. For example, a CCTV or a machine vision camera.

Detecting of the type of plug present in the sample inlet can be based on a variety of detected features. For example, referring to FIG. 15, images can be taken of the sample inlet and the waste outlet for detection of an interface in each of the sample inlet and the waste outlet. Adjacent sample plugs and segmenting fluid plugs generate a detectable interface. The images can be taken by a single camera focused on the sample inlet and the waste outlet or by separate cameras, each singly focused on one of the sample inlet and the waste outlet. When the detected image of the sample inlet has a concave interface and the detected image of the waste outlet has a convex interface, the sample loop is filled with sample. At this point, a signal is sent to actuate the injection valve, with the sample loop full of sample, to the second position for injection of the sample into the liquid chromatography machine. During injection, the segmenting fluid plug is flowed through to the waste outlet. The injection valve remains in the second (inject) position for sufficient time for injection of the sample into the liquid chromatography machine. Sufficient time is calculated based on the volume of sample to be injected and the flow rate, which are known parameters. Actuation from the first position back to the second position can be signaled again when the detected interfaces are concave at the sample inlet and convex at the sample outlet, indicating that the sample loop has again been filled with sample and is ready for injection. The automated actuation of the injection valve can continue based on the detected interface until all sample plugs are processed.

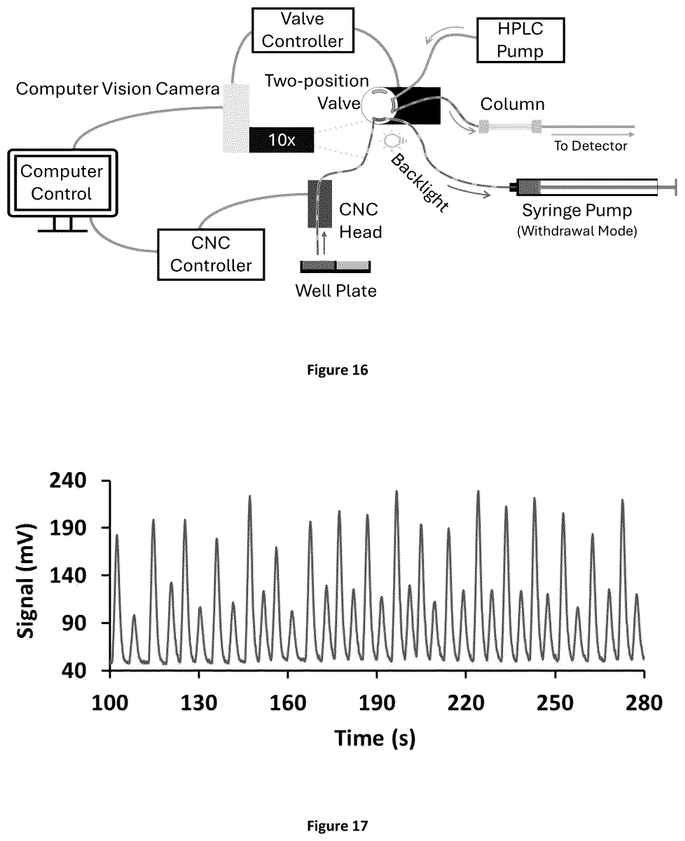

In embodiments, the camera can be a machine vision camera and detection of the sample plug or segmenting fluid plug presence in the sample inlet can be based on detection of a phase change in the sample inlet. FIG. 16 illustrates a schematic set-up of a system for automatic injection into a liquid chromatography column.

For example, gray scale images can be obtained by the machine vision camera and analyzed for the gray value to determine a phase at a pre-set region of the sample inlet and changes in phase at this region can be used to signal actuation of injection valve. A sample plug present in the sample inlet is distinguishable from a segmenting fluid plug present in the sample inlet by the gray value in the images. In particular, segmenting fluid appears light (higher gray value) while the sample appears dark (lower gray value). The sample array is prepared with droplets that are formed with a length in excess of a length of an opaque region between the sample inlet and the sample loop. For example, the sample inlet can be in the form of an inlet tube and can be connected to the sample loop with connector, such as a nut, which defines an opaque region through which the plugs travel when transferring from the sample inlet to the sample loop. A camera can be focused at the region of the sample inlet for phase change determination.

The images can be compared to a segmenting fluid plug gray value threshold and a sample plug gray value threshold to determine a phase of the sample inlet. The phase present in the image is a sample plug phase when the gray value of the image is lower than the sample plug threshold gray value and is a segmenting fluid phase when the gray value of the image is higher than the segmenting fluid threshold gray scale value. The camera continuously obtains images as the sample array is passed through the sample inlet and for each images determines a gray value, compares the gray value to the thresholds to determine a phase present in the images of the sample inlet, and compares the phase to the phase determined for the previously taken image. The controller than receives a signal based on the comparison for actuation of the injection valve when a change of phase is detected. The injection valve is actuated to the first, load position, when a phase change from a segmenting fluid phase in the previously image to a sample fluid phase is detected so that the sample fluid plug present in the sample inlet is loaded into the sample loop. The injection valve is actuated to the second, inject, position when a phase change from a sample fluid phase in the previously image to a segmenting fluid phase is detected to inject the sample fluid plug present in the sample loop into the liquid chromatography column and flow the segmenting fluid plug through the sample loop and out the waste outlet. Repeated actuation based on the detection of phase changes in the images can be continued until all of the sample plugs are injected into the liquid chromatography machine.

In another embodiment, a calculated arrival time of the plugs to the sample loop can be used for automated actuation of the injection valve. In such embodiments, the sample array can be prepared with plugs having a length less than the length of the opaque region between the sample inlet and the sample loop. A camera is focused on two regions of the sample inlet. The first region is disposed immediately upstream of the opaque region and the second region is set a predetermined distance downstream of the second region. For example, the first and second regions can be spaced about one inch apart. A phase in the image, for example, at each region can be determined as described above, using the gray value comparison. The phase of the plug in the sample inlet is used for determining whether a phase of the sample inlet at the second region is a segmenting fluid plug phase or a sample plug phase to thereby determine whether the calculated arrival time is for a sample plug or a segmenting fluid plug. Actuation of the injection valve is based on predicted time of arrival of a given plug based on a calculated velocity. Arrival times of a given plug can be determined by storing the time that the respective plug head reaches each of the first and second regions and calculating a difference in time of arrival at the first and second regions for the plug. The head of the plug can be determined by detecting an interface between a sample plug phase and a segmenting plug phase at each of the first and second regions using the detection of a change in phase through gray scale comparison, as described in the preceding paragraph. The velocity can be calculated by dividing the distance between the first and second regions by the difference of arrival time. The arrival time is then calculated by dividing the length of the opaque region by the velocity and then adding the quotient to the current time to thereby give the arrival time of the plug. An array of arrival times of sample plugs and segmenting fluid plugs is generated by adding the quotient to a previously calculated arrival time of a plug. Actuation is triggered or the signal for actuation is generated by comparing a current time to the array of arrival times. The injection valve is actuated to a first, load position, when the when the arrival time of a sample plug in the array matches the current time and is actuated to the second, injection, position when the arrival time of a segmenting fluid public matches the current tie. Actuation based on the arrival time arrays repeated until all sample plugs have been injected. FIG. 17 is a graph showing a sequence of 20 nL sections injected from 60 nL droplets of alternating intensity using the arrival time calculation.

### EXAMPLES

### Example 1

### Chemicals and Reagents

Thiourea, acetophenone, propiophenone, bentazon, caffeine, acetaminophen, and acetylsalicylic acid, yeast nitrogen base with supplemental amino acids, and nucleobases were purchased from Sigma-Aldrich (St. Louis, MO). Optima LC-MS grade water (H₂O), acetonitrile (ACN), methanol (MeOH), and formic acid (FA) were purchased from Fischer Scientific (Fair Lawn, NJ). Competitor substrates were obtained from BASF (Limburgerhof, Germany).

### Droplet Generation

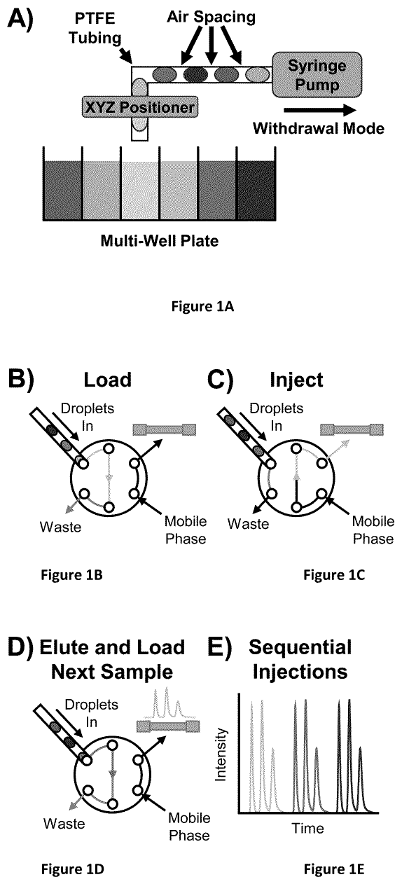

Sample plugs were generated from 96-well plates. Samples were drawn into 0.8 μm i.d.×1.6 mm o.d. polytetrafluoroethylene (PTFE) tubing (Cole-Parmer, Vernon Hills, IL) that was initially filled with MeOH using a 10 ml syringe (Hamilton Company, Reno, NV) coupled to a Fusion 400 syringe pump (Chemyx, Strafford, TX) operated in withdrawal mode at 300 μL/min. Using an xyz-positioner (Cameron Micro Drill Press, Sonora, CA) that was controlled by a G-code script written in-house, the tip of the PTFE tubing was submerged into a sample stored in the 96-well plate for 1 s to draw sample, moved to the next sample well (while withdrawing air as the segmenting fluid between sample plugs during approximately 1 s of travel), and then submerged into the well containing the next sample, resulting a 2 s/sample plug generation. This process was repeated until all samples were loaded from the plate into the tubing, with a plug containing wash solvent between each sample when required to reduce carryover (FIG. 1A). Sample plugs and the intervening air plug (segmenting fluid plugs) were on the order of 4 μL in volume.

### Instrumentation

LC experiments were performed using a Vanquish Flex system (Thermo Scientific, San Jose, CA). The system was composed of a binary pump, an autosampler, a thermostatted column compartment, and a diode array detector. UV detection was performed by monitoring absorbance at 210 or 254 nm at a frequency of 200 Hz with a response time of 20 ms. Xcalibur (Thermo Scientific) was used for instrument control and FreeStyle (Thermo Scientific) was used for data processing. Isocratic mobile phase for fast separations was premixed and pumped using the binary pump set to 100% A. Fast LC separations were performed using a Poroshell 120 StableBond C18 column (2.1 mm i.d.×5 mm length, 2.7 μm) purchased from Agilent (Santa Clara, CA). Conventional LC separations were performed using a Kinetex XB-C18 column (2.1 mm i.d.×30 mm length, 2.6 μm) purchased from Phenomenex (Torrance, CA).

MS experiments were performed using a TSQ Quantis triple quadrupole MS (Thermo Scientific). The electrospray ionization source was operated in positive mode under the following conditions: Spray voltage, 4.7 kV; Sheath gas flow rate, 60 (arbitrary); Auxiliary gas flow rate, 24.4 (arbitrary); Sweep gas flow rate, 3.7 (arbitrary); Ion transfer tube temperature, 350° C.; Vaporizer temperature, 500° C. Multiple reaction monitoring used detect fragmentation channels 241.1->199.0 m/z for bentazon and 257.0->215.0 m/z for 6-hydroxybentazon. The RF lens voltage was 61 V for bentazon and 63 V for 6-hydroxybentazon. The dwell time was 40 ms for each channel, the collision energy was 10 V, the collision cell pressure was 1.5 mTorr, the quadrupole 1 resolution was 0.7, and the quadrupole 3 resolution was 1.2.

### Segmented Flow Injector

A commercial autosampler was bypassed and replaced with a segmented flow injector for high-throughput analyses using an injection method in accordance with the disclosure (FIG. 1). The segmented flow injector for performing a method of the disclosure was comprised of a standard six-port valve from VICI (Houston, TX), which was equipped with an electric actuator and controller from VICI. The valve had a 1 μL PEEK sample loop spanning ports 3 and 6. Sample plugs stored in PTFE tubing were infused into port 1 of the valve using a Fusion 400 syringe pump (Chemyx). The valve was initially set to position 1 to allow a sample plug to enter the 1 μL loop from port 3 (FIG. 1B). Once the sample had filled the loop and had started to be visible in the waste tubing exiting port 6, the valve was switched to position 2 to inject the sample on to the column (FIG. 1C) and was immediately switched back to position 1 to direct any uninjected sample to waste and load the next sample plug (FIG. 1D). This process was repeated for all samples remaining in the PTFE tubing and signals for each subsequent injection were observed on the same chromatogram (FIG. 1E).

### Cytochrome P450 Inhibitor Screen

Cultures were grown in histidine dropout growth media containing the following components per liter: 0.85 g yeast nitrogen base, 2 g yeast drop-out mix, 0.31 g supplemental amino acids and nucleobases (without histidine), and 20 g glucose or galactose. A plasmid encoding the cytochrome P450 enzyme CYP81A24 from Echinochloa phyllopogon was provided by BASF in a pESC vector under His selection. Saccharomyces cerevisiae strain BY 4742 was transformed with this plasmid, and the resulting colonies were used to inoculate cultures in 2% glucose media. After a day of growth at 30° C. in culture tubes, the media was exchanged for 2% galactose media supplemented with 0.5 mM 5-aminolevulinic acid in order to induce CYP3B expression. Induction proceeded overnight at 30° C., and then the media was exchanged again for fresh 2% galactose media with 0.5 mM 5-aminolevulinic acid. After the yeast cells were resuspended, 250 μL of yeast culture was added to each well of a 96-well culture plate, along with 1% dimethyl sulfoxide, 20 UM bentazon, and 5-50 UM of a competitor substrate. After 6 h and 24 h of shaking at 30° C., 50 μL samples of each well were taken and immediately combined with 50 μL methanol in a 96-well analysis plate. Analysis plates were centrifuged 10 min at 1000×g to pellet cell debris, then the supernatant was diluted 10-fold with 50/50 MeOH/H₂O prior to analysis by conventional or fast LC-MS in accordance with the disclosure, as described above.

### Injection Speed Testing

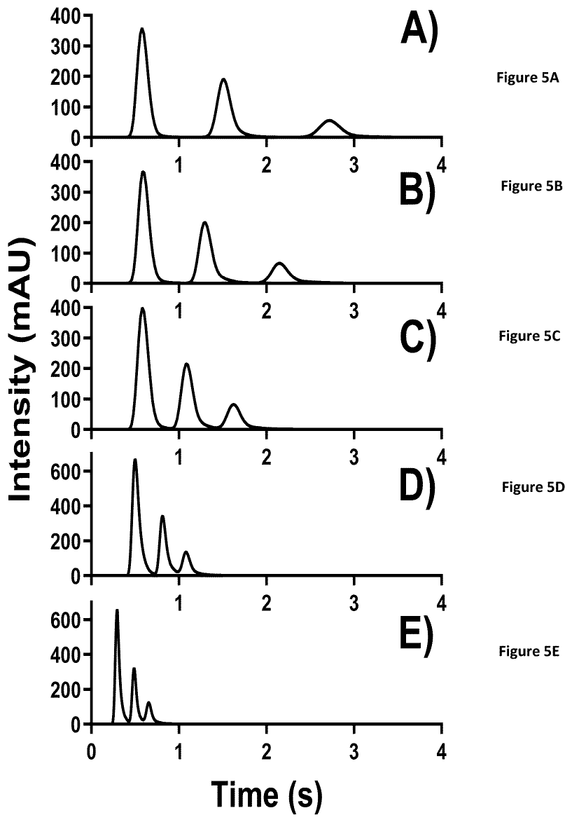

Injection speed and repeatability was assessed using a set of standard small molecules: thiourea, acetophenone, and propiophenone. Fast LC methods using short, 2.1×5 mm columns were developed by tuning the mobile phase flow rate, organic content, pre-column heater temperature, and column oven temperature (FIG. 5). This approach is no different from classical method development on conventional length columns. Minimizing extra column volume was useful for the small columns used for fast LC separations. Separation of the three test analytes in 1 s was achieved.

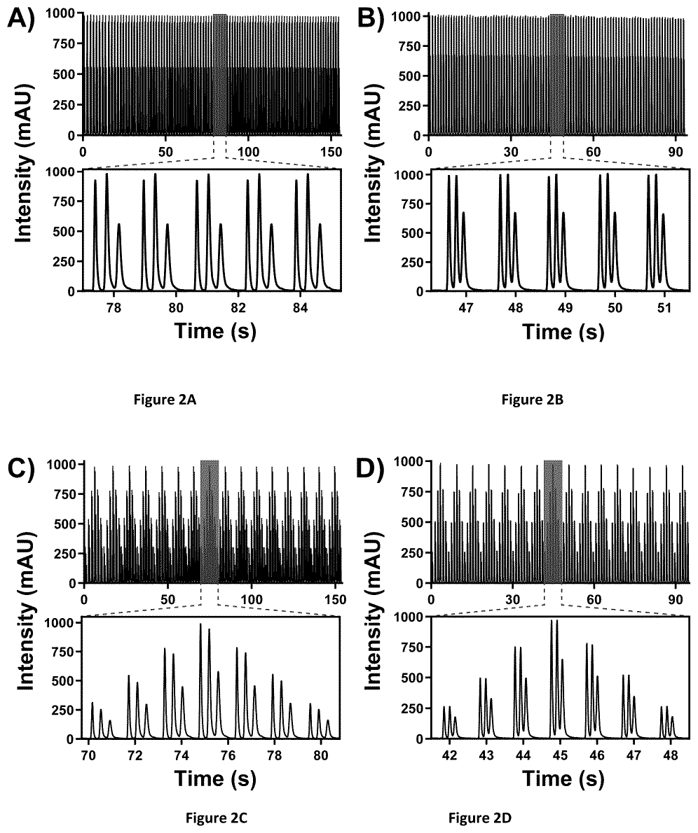

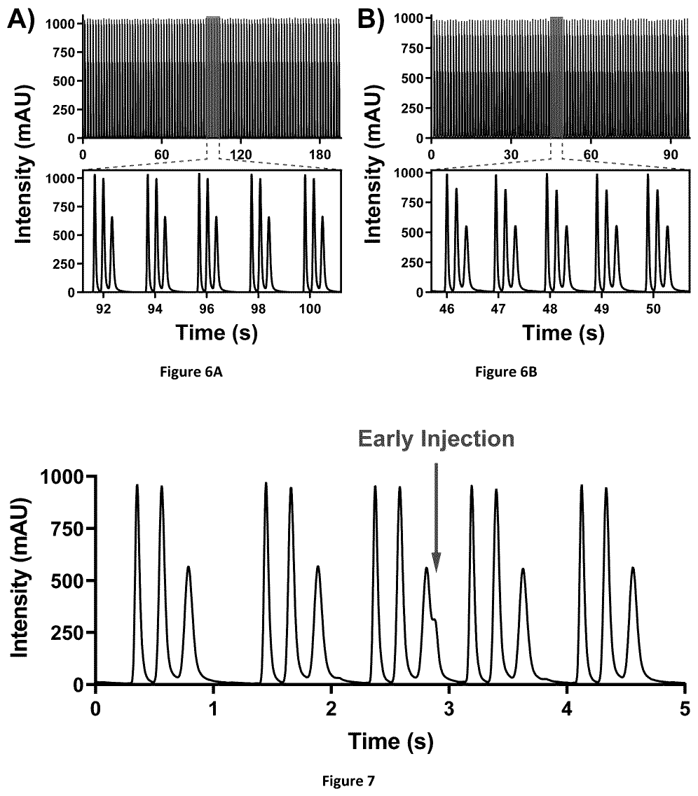

FIGS. 2A and 2B show injections at rates of 1.6 and 1.0 s per injection. Peak area relative standard deviations (RSDs) were 1.0, 0.5, and 0.7% at 1.6 s per injection and 1.1, 1.2, and 1.2% at 1.0 s per injection for thiourea, acetophenone, and propiophenone, respectively. The repeatability of segmented flow injections was comparable to injections performed at similar rates when a single, continuous stream of sample was infused into the valve using a syringe pump (FIG. 6). These observations indicate that droplets can be infused into a standard, six-port valve and injected onto an LC column in a consistent manner.

To further demonstrate the performance of the injector, a series of dilutions of the thiourea, acetophenone, and propiophenone mixture were deposited into a 96-well plate. FIGS. 2C and 2D show the analysis of these samples at 1.6 s and 1.0 s per injection, again with good repeatability. One injection being performed per second enabled the analysis of a 96-well plate in 1.6 min. Without intending to be bound by theory, it is believed that with such throughput, 100,000 samples could be analyzed by LC in 28 h, where this would require 70 d of analysis time using a 1 min conventional method. Methods in accordance with the disclosure have the capability to yield a 7-fold improvement in throughput over the fastest commercially available autosampler when used for HTS.

A flow rate of 5 mL/min was required to perform separations at a rate of 1.0 s per injection. At this flow rate, compression and decompression of the packed bed due to changes in pressure during valve actuation could damage the column and cause the separation efficiency to deteriorate over time. It was estimated that the StableBond C18 column used experienced several thousands of injections without a notable loss in efficiency. Short columns from multiple vendors packed with different resins were also tested, and the rate of deterioration was variable depending on the vendor and packing material.

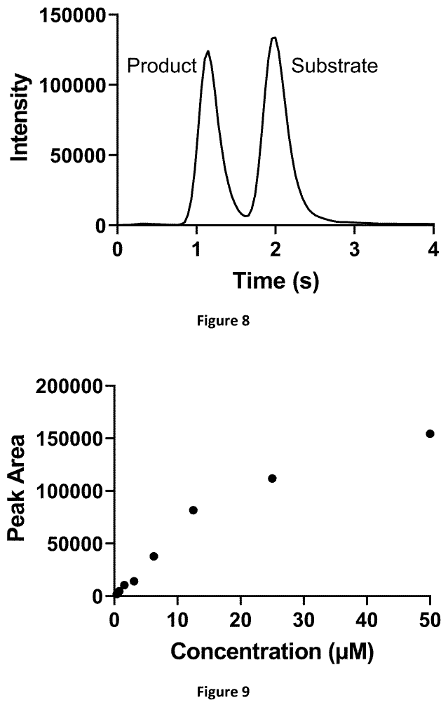

Timing of successive injections must be considered when performing high-throughput separations with minimal extra time in between injections. FIG. 7 shows an example of a poorly timed injection. The fourth injection of the sequence was performed as the final peak from the previous injection reached the UV detector, which caused a shoulder to emerge on this peak that was not present for other injections. The peak shoulder was caused by a fluctuation in UV detector response due to changes in flow rate during valve actuation. This shouldering impaired measurement repeatability (>2% peak area RSD), but could be mediated by increasing the time between injection events (e.g., by lowering the droplet infusion rate, increasing the amount of carrier fluid between droplets, or decreasing chromatographic retention). Another concern related to injection timing is the partial injection of a sample onto the column, resulting in a portion of the air spacer also being injected. When this occurred, a notable change in separation was not observed, but signal intensity was lower due to less of the sample being injected (FIG. 8). The loop was monitored for droplets entering the loop and actuated the valve when the droplet had filled the loop. To facilitate this, the droplets were 4× the volume of the loop. When using oil-based segmenting fluids, injection of the oil into the column can be detrimental to the column performance and a regeneration step as described above may be necessary if oil is injected into the column. Sample Carryover Analysis

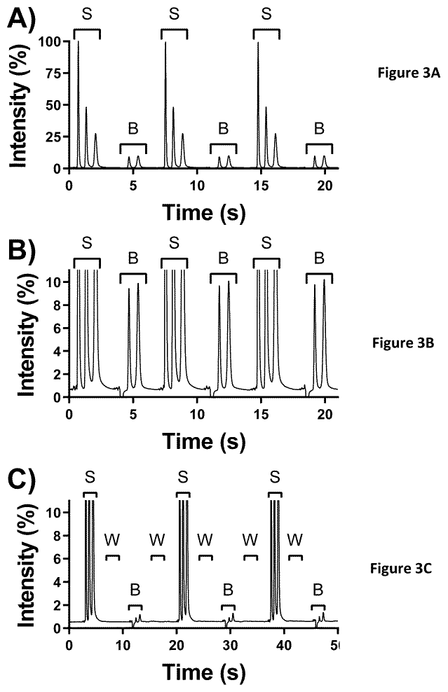

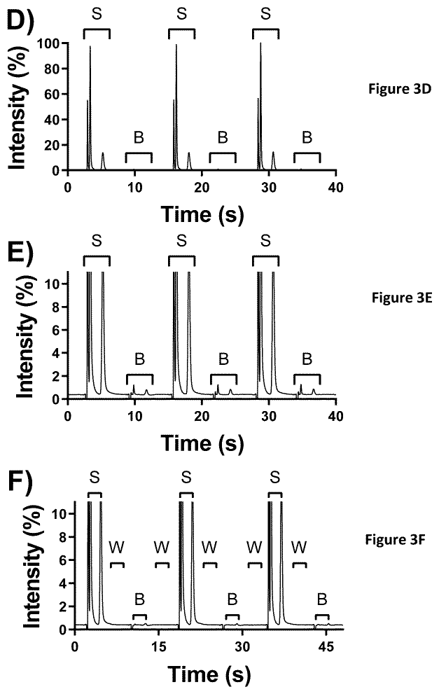

Carryover between sample injections was investigated using two standard mixtures. The first mixture contained thiourea, acetophenone, and propiophenone. Droplets were generated so that an H₂O blank was placed in between each sample droplet. Signal associated with the injection of a blank droplet would be indicative of analyte carryover from a neighboring sample droplet. FIG. 3A shows three alternating injections of the first mixture and blanks. A zoomed in view of this trace shows that the peak for thiourea is not present above the solvent peak, yet 9-10% carryover of acetophenone and propiophenone is observed (FIG. 3B). A wash droplet comprised of ACN was added in between all sample and blank droplets. The ACN wash droplets were not injected, but served to remove any residual sample collected on the walls of the PTFE tubing or valve channels. Acetophenone and propiophenone carryover was reduced to <1% when ACN wash droplets were present (FIG. 3C). Any effects that the addition of wash droplets had on throughput could be compensated for by infusing the droplet train into the valve at a faster rate.

An additional mixture was tested for carryover when thiourea did not appear to carryover yet acetophenone and propiophenone demonstrated substantial carryover. As before, droplets were generated from a well plate so that an H₂O blank was placed in between each sample droplet, which contained acetaminophen, caffeine, and acetylsalicylic acid. FIG. 3D shows three alternating injections of the second test mixture and blanks. In this case, only 1% carryover or less was observed for all analytes without using wash droplets. Carryover was reduced to <0.1% by including an ACN wash droplet in between each sample and blank droplet. This demonstrated that carryover was analyte dependent, likely due to differences in adsorption to tubing and wetted components of the valve. Segmenting fluid, material of droplet transfer tubing, and wash droplet composition can be tuned for given samples to be analyzed to minimize carryover.

### Application to a Cytochrome P450 Inhibitor Screen

The above results indicate that segmented droplets can be injected onto an LC column in a rapid manner to increase the throughput of LC separations. Next, the segmented flow injector in accordance with the disclosure was applied to the high-throughput analysis of enzymatic reactions. Inhibitors of the cytochrome P450-catalyzed hydroxylation of bentazon were screened—this reaction is shown in Scheme 1.

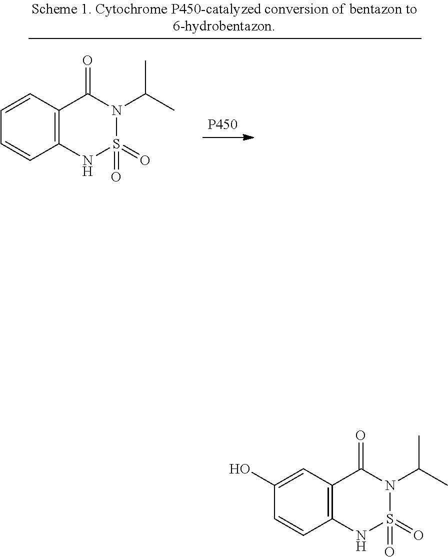

The reactions were performed as whole cell yeast reactions, making UV detection insufficient due to increased sample complexity.

A LC-MS method with the sample injection method in accordance with the disclosure achieved baseline resolution of the substrate and product in 3 s (FIG. 9). An MS acquisition rate was used that was fast enough to sufficiently capture eluting peaks (˜15 points were collected per peak) while ensuring that the dwell time was long enough to achieve sufficient signal intensity. The speed of this separation was lower than what was achieved in FIG. 2, as the flow rate had to be lowered to 1.5 mL/min for an acceptable compromise between separation speed and ionization efficiency without flow splitting. The product coeluted with unretained matrix components under these conditions, causing ion suppression and poor quantitation. Retention was increased by reducing the amount of ACN in the mobile phase to 25%, which allowed the product and substrate to separate from unretained matrix components in 6 s. Ion suppression was reduced and quantitation was improved under these conditions, at the cost of reduced throughput. This illustrates that although MS is a powerful tool for reducing data complexity in fast LC, care must be taken to avoid coelution with other sample components.

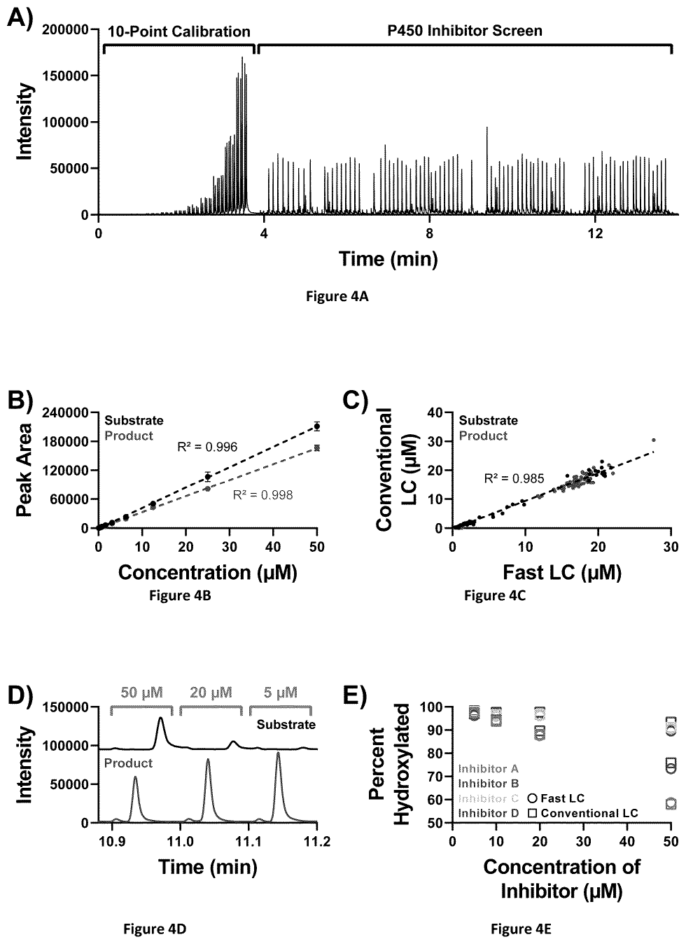

A method cycle time of 6 s was used to screen the enzymatic hydroxylation reactions. FIG. 4A shows the total ion chromatogram from the screen-a set of 10 standards was first analyzed in triplicate, followed by 96 enzymatic reactions. Calibration curves for bentazon and 6-hydroxybentazon are shown in FIG. 4B. Excellent linearity was observed for both analytes (R2=0.996-0.998) over multiple orders of magnitude using the segmented flow injector. The enzymatic reactions were analyzed using a more conventional LC method for enzyme screening. The cycle time of the conventional LC method was 3 min: 1 min for injection using the commercial autosampler, 1 min for a linear gradient from 5-50% B, and 1 min for column wash and equilibration. FIG. 4C shows a comparison of analyte concentrations measured using fast LC (6 s per injection) and conventional LC (3 min per injection). Critically, these data show that measurements made with the two methods are highly correlated (R2=0.985).

It was demonstrated that the amounts of substrate and product present during enzymatic reactions can be measured with high accuracy using the segmented flow injector. Differences in enzymatic activity (i.e., “hits”) can also be readily observed in the data. Qualitative differences in signal intensity for the substrate and product in the presence of Inhibitor A are observed in FIG. 4D. Additionally, the relative amounts of hydroxylated bentazon measured using fast LC are consistent with the measurements made using conventional LC (FIG. 4E). These findings illustrate the potential for fast LC to improve throughput during HTS of enzymatic reactions. This testing confirmed that the injection method in accordance with the disclosure can be used for screening enzymatic reactions, and that both the quantitative data and enzymatic activities measured with the injector were highly correlated with a conventional 3-min LC method using a traditional autosampler for injection.

### Example 2

### Chemicals and Reagents

Thiourea, acetophenone, propiophenone, 2,5-dihydroxybenzoic acid, phenylacetic acid, trifluoroacetic acid (TFA), propylamine, and benzylamine were purchased from Sigma Aldrich (St. Louis, MO). Trans-beta-nitrostyrene and acetonitrile were purchased from Millipore Sigma (Burlington, MA). Methanol was purchased from Fisher Scientific (Hanover Park, IL). Water was purchased from ThermoFisher (Grand Island, NY). Perfluorodecalin was purchased from Oakwood Products (West Columbia, SC).

### Instrumentation

Unless stated otherwise, all separation experiments were performed using a Luna C18 (2) HPLC guard column (20 mm length×0.3 mm i.d., 5 μm particles) from Phenomenex (Torrance, CA). For LC-UV experiments, a binary Waters Acuity Arc LC pump (Milford, MA) coupled to a LINEAR UVIS-205 absorbance detector (Auburn, CA) set to 214 nm was used. Data was collected at 20 Hz through a NI USB-6008 data acquisition card (National Instrument, Austin, TX, USA) controlled by a custom LabView program. Prism 10 was used for data processing. For all LC-MS experiments, a 1290 Infinity II LC pump (Agilent Technologies, Santa Clara, CA) coupled to an Agilent 6410 Triple Quadrupole mass spectrometer via a capillary electrophoresis sheath flow electrospray source (Agilent G1607B) was used. Electrospray ionization was achieved under the following conditions: temperature, 300° C.; gas flow, 10 L/min; nebulizer, 15 psi; capillary voltage: 3000 V; scan time: 10 ms; operating mode, positive.

### Synchronous Droplet Generation and Injection

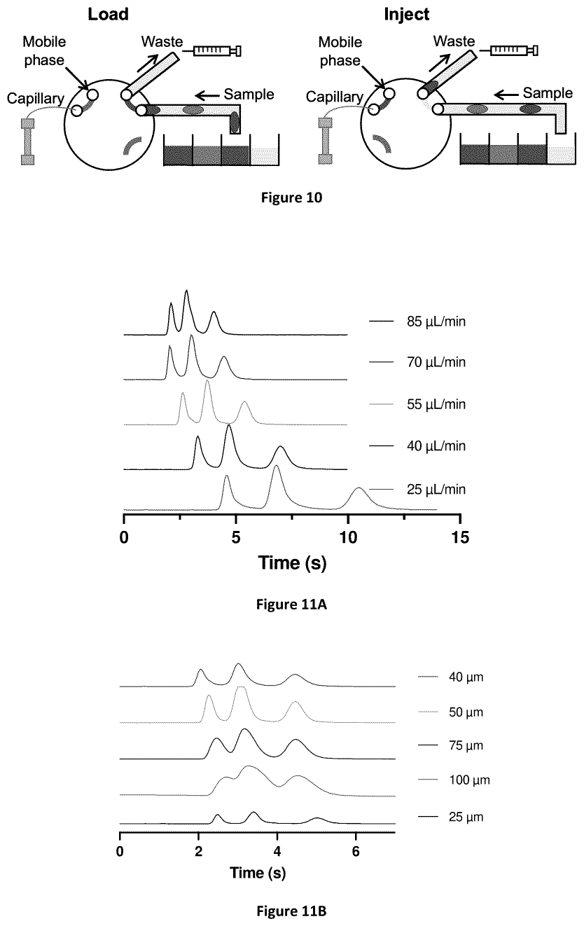

Synchronous droplet generation and injection was achieved by using a four port injection valve (C74MH, VICI AG-Valco Instruments, Houston, TX) with 20 nL internal injection volume and equipped with an actuator (EHCA-CE, VICI AG-Valco Instruments, Houston, TX). (FIG. 10) Two ports on one side of the valve were connected to the LC binary sample pump and the column, respectively. On the other side of the valve, two pieces of perfluoroalkoxy alkane (PFA) tubing (one for sampling, one for waste, 40 cm and 25 cm in length, respectively) with 360 μm o.d. and 100 μm i.d. (IDEX Health & Science, Rochester, NY) were connected. A computer numeric control (CNC) XYZ-positioner was used to position the inlet of the sampling tube for collecting samples from a well-plate for injection. The outlet of the waste tube was connected to a 25 μL Hamilton syringe (Reno, NV) mounted on a Fusion 400 syringe pump (Chemyx, Strafford, TX) operated in withdrawal mode. Droplet samples segmented by perfluorodecalin (PFD) were generated by using the CNC to position the sampling tube inlet alternatingly in wells containing sample and PFD while the syringe pump was withdrawing at 1.5-2.6 μL/min depending on the cycle time for different analyte mixtures. The droplets flowed through the sampling tube and into the internal sample groove of the valve for injection. Timing for actuating the valve was determined by observation of the droplet passing the base of the non-transparent PEEK ferrule (VICI), which is 1 cm away from the bore. Uninjected sample was collected in the waste tubing. Droplets were at least 1 cm long in the 100 μm i.d. tube, corresponding to 80 nL, and another 80 nL excess volume was used to guarantee overfilling the loop and successful injections.

For most tests, a standard mixture of 13.3 mM thiourea, 6.7 mM 2,5-dihydroxybenzoic acid, and 16.7 mM phenylacetic acid aqueous solution with 20% acetonitrile and its two-fold dilution were used as the samples. For standard carryover tests, a mixture of 16 mM thiourea, acetophenone, and propiophenone aqueous solution with 20% acetonitrile was used.

The method in accordance with the disclosure was used to provide fast separations of a thiourea, 2,5-dihydroxybenzoic acid, and phenylacetic acid test mixture. FIG. 11A shows that when using the capillary column (20 mm length×0.3 mm i.d., 5 μm) it was possible to increase the flow rate from 25 to 85 μL/min and maintain resolution of these test compounds and reduce the time to 4 s. Increasing the flow rate from 70 to 85 μL/min increased back pressure from 3.6 k to 4.4 k psi which is close to the stated column pressure limit which of 345 bar or ˜5 k psi with a modest improvement in speed; therefore, 70 μL/min was used for the trials. A key to maintaining resolution was Minimizing the extra column band broadening was observed to be important for maintaining resolution. The pre-column tube connecting the injector valve and the column was 25 μm i.d. and 5 cm in length, giving only 24.5 nL pre-column dead volume. The largest potential source of extra column band broadening was the connection between column and detector. A 10 cm length was required to reach from the column exit to the detector. Reducing the inner diameter of this tubing improves resolution but increases backpressure and decreases signal (FIG. 11b). The latter effect is because the inner diameter of the connector tubing is also the pathlength in the flow through cell for the detector. Based on these trade-offs, a 10 cm length of 40 μm ID tubing was selected for connection.

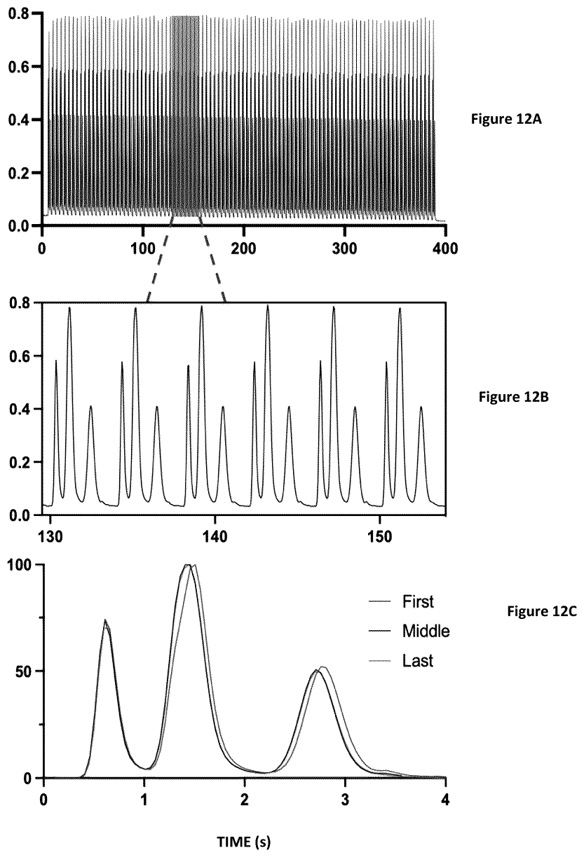

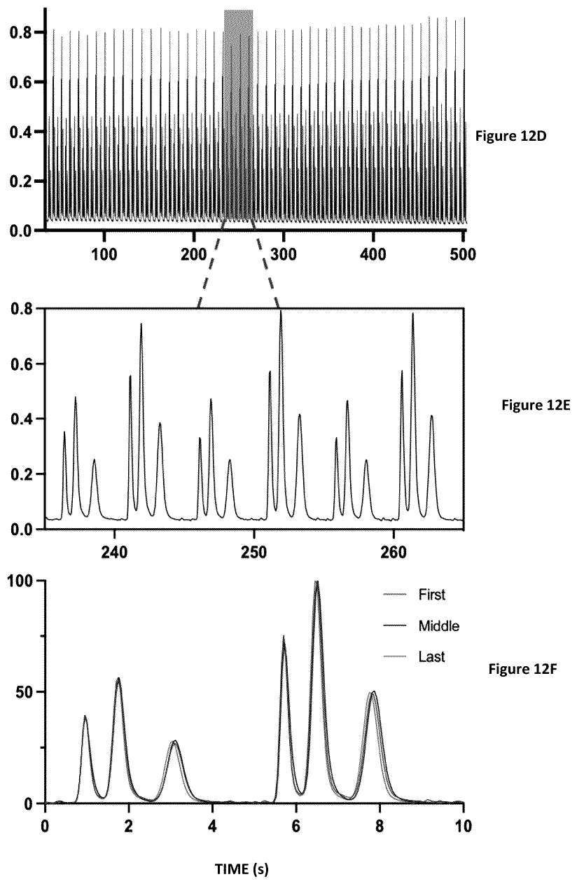

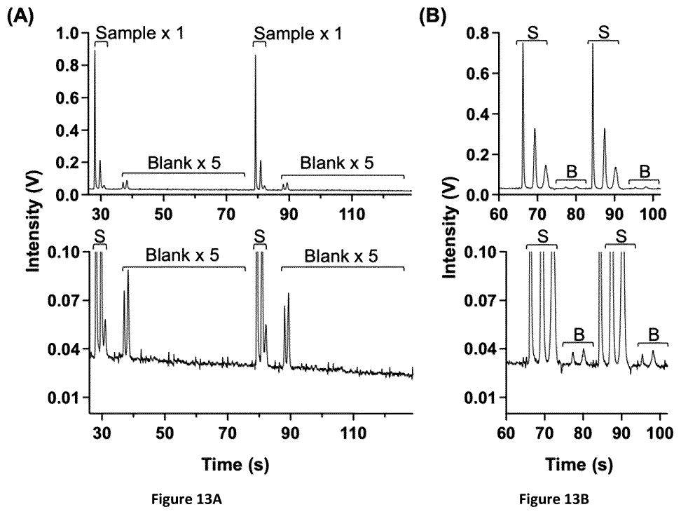

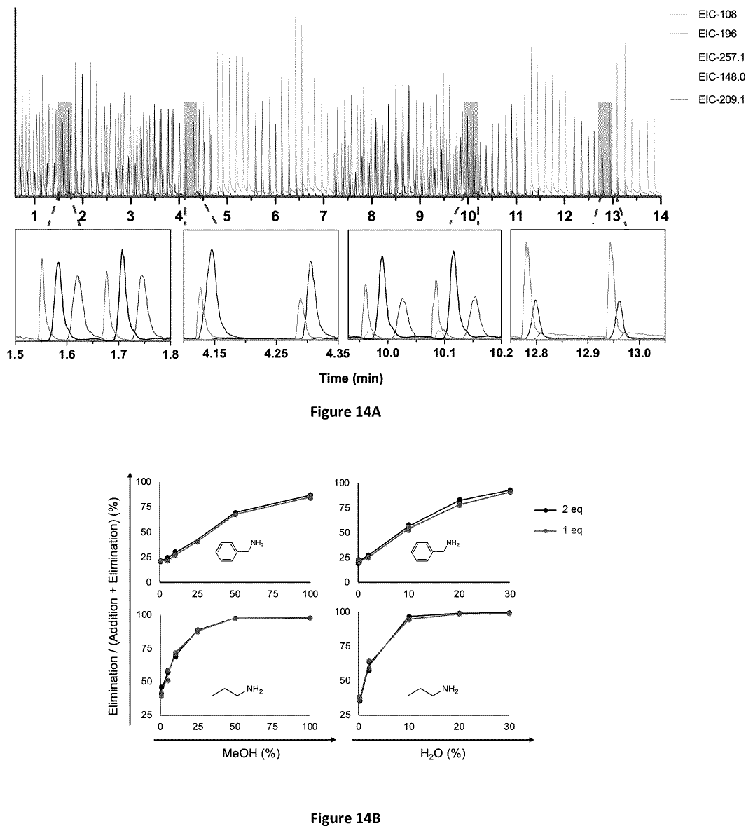

To test the robustness and repeatability of this rapid separation, 96 injections of the test mixture were performed. For this test, the solution was continuously infused into the injection port via a syringe pump at 2 μL/min and injections were made by alternating the valve between load and inject on a 4 s cycle with 2 s in load and 2 s in inject position. Using this method, 96 injections were completed within 6.4 min. RSD for the peak heights of each analyte were 1.10%, 1.75%, 1.55%, respectively (FIG. 12a, b). The separation performance was consistent and repeatable in terms of peak shape and retention time, which can be visualized by overlapping the normalized chromatograms of the first, middle, and the last separations. (FIG. 12e) It was observed that the same column could be used repeatedly under such conditions. These results indicate that the capillary LC column is sufficiently stable to the high flow rates and multiple valve actuations to robustly separate consecutive samples.

The method of injection in accordance with the disclosure utilized a syringe pump that was set at 2.6 μL/min. The well plate was loaded with the PFD oil as the segmenting fluid and the standard samples of two different concentrations for segmented flow injection test. These samples were alternately injected. The droplet generator was programmed to dwell in sample wells for 3.7 s and in oil wells for 0.3 s, therefore the theoretical injection interval should be the same as the separation time which is 4 s. (FIG. 12c, d) However, the fluid flow in the PFA tubing can be slightly paused during the valve position switch because the two connecting ports are temporarily sealed by the rotor surface instead of opened to the rotor groove during the transition. As a result, a 0.4-0.5 s delay occurs after each valve actuation, and the total analysis time for the 96 separations was 7.8 min, longer than the 6.4 min for continuous injections.

The RSD for the peak heights of each analyte were 3.06%, 2.62%, 2.46% for high concentration samples and 2.76%, 2.67%, 2.23% for low concentration samples, respectively. Resolution was maintained throughout the entire sequence of injections as visualized by overlapping and normalizing the first, middle, and last chromatograms from the sequence (FIG. 12f). These data indicate the column and separation are stable to these repeated droplet injections. It was observed that performance was consistent throughout the entire research time span with thousands of injections of various analyte species, as long as the system remained clog-free and the system back pressure was below the column pressure limit of 5k psi.

With normal, successful injections, column performance was maintained; however, if PFD entered the column e.g., from a mis-timed injection, the column performance was significantly degraded. Column performance could be restored by pumping 100% acetonitrile through the column for ˜2 min at the separation flow rate.

### Carryover and Elimination

A carryover test for the mixture of thiourea, acetophenone, and propiophenone was performed by injecting 5 acetonitrile (blank) droplets following each standard sample droplet (FIG. 13a, b). Analytes were detected in all first blank droplets, indicating carryover exists in this system but can be eliminated by one wash droplet. Subsequently, a range of wash droplet volumes were evaluated by introducing a specific volume of wash droplet between the sample and the first blank in the droplet array, without injecting it (FIG. 13c, d). It was observed that that just a 10 nL wash droplet (100% acetonitrile) was sufficient to eliminate >96% carryover, and the impact of 10 nL and 100 nL wash droplets was remarkably similar. This finding suggests that a wash droplet as small as 10 nL could be adequate for mitigating the carryover.

### Organic Reaction Screen

48 variations of a Michael addition of amines to a nitrostyrene in different solvent systems were screened in duplicate (Scheme 2).

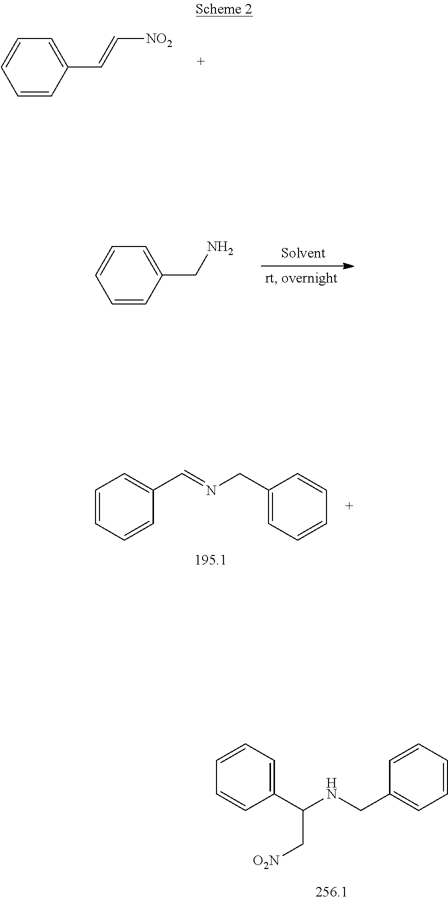 [SMILES: O=[N+]([O-])/C=C/c1ccccc1 ; NCc1ccccc1 ; C(=N\Cc1ccccc1)/c1ccccc1 ; O=[N+]([O-])CC(NCc1ccccc1)c1ccccc1]

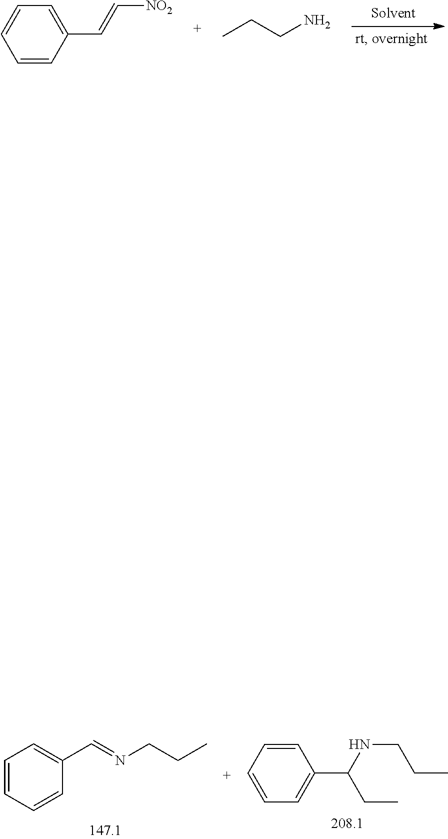

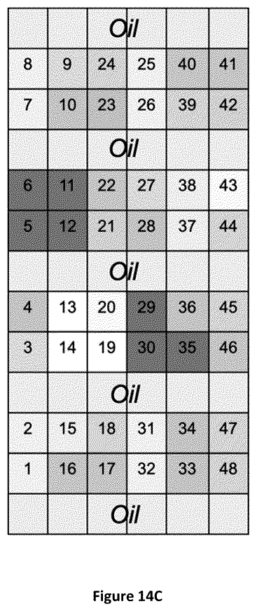

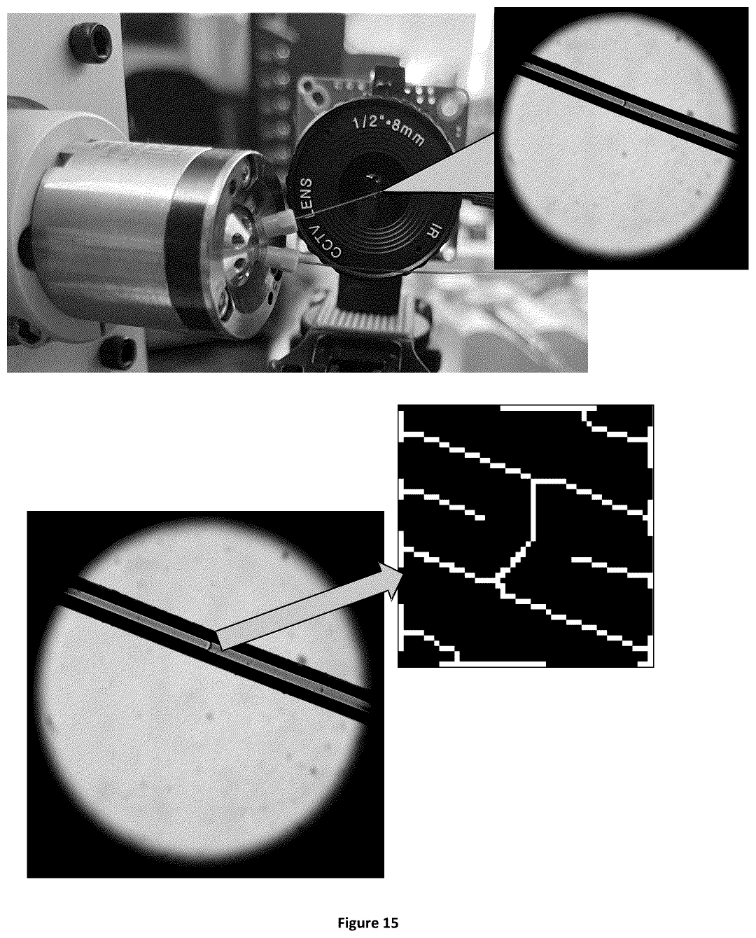

Stock solutions of trans-B-nitrostyrene in acetonitrile or methanol were filtered and dispensed in 48 Eppendorf tubes in a final concentration of 1 mg/ml and 1 mL volume. The 48 reactions were divided into 4 groups of 12 in terms of variables to screen: groups 1 and 3 each contained two and one equivalents of benzylamine, respectively. Groups 2 and 4 each contained two equivalents and one equivalent of propylamine, respectively. In each group, there were 12 solvent systems, comprising the following compositions: 0%, 0.2%, 2%, 10%, 20%, and 30% water in acetonitrile, as well as 0.5%, 5%, 10%, 25%, 50%, and 100% methanol in acetonitrile. After adding amines to each tube, the reaction mixtures were incubated at room temperature overnight and subsequently pipetted into 48 different wells of a 384-well plate. (FIG. 14c) Droplet samples of all reactions segmented by perfluorodecalin oil were generated and analyzed by the fast LC-MS method described above.

To facilitate the analysis, the capillary LC was interfaced to a mass spectrometer which allowed measurements even if analytes were not sufficiently resolved from other reaction components or they do not have sufficient absorbance. The screened reactions are shown in scheme 2. Prior research into Michael addition of amines to nitrostyrenes has reported the creation of N-butyl or benzyl imines as side products via a retro-aza-Henry-type transformation in tandem with the Michael-adducts. Mechanistic study into the nitroalkane elimination has concluded that this process is dual-catalyzed by the presence of protic solvent and an excess of amines. Using 1 eq of amine yields only 58% imine, but 1.5 eq and 2 eq yield 95% and 99%, respectively. Adding small amount of protic solvents such as 0.2% (V/V) water or 0.5% (V/V) MeOH into acetonitrile may drive the synthesis of the imines from 12% to 82% and 85%, respectively. This ability to vary output of the reaction provides a convenient test of the high-throughput capillary LC.

FIG. 14a shows the trace for the entire capillary LC-MS/MS screen with zoomed view of selected sections. The chromatograms show that it was possible to partially resolve the reactants and products for the different reactions in 5 s. This resolution was stable throughout the screen. The use of MS further allowed isolation of specific analytes.

Using peak area from the MS traces, it was possible to semi-quantify the reaction results. Using this approach, it was found the expected qualitative trends in product formation as a function of protic solvent content and equivalent of amines. Specifically, as the percent water or methanol is increased in the reaction mixture, the fraction of product that was imine increased. Likewise, the imine fraction also increased with amine equivalents added. Accuracy of results were marginally affected by carry-over. Studies of the reaction mixture showed that carryover only exists in the first blank injections. (FIG. 13e) The peak heights for the carryover signals averaged 6.8% of the samples, with a range of 0.4% to 11.6%. As discussed above wash droplets could be used to minimize this effect.

The screening experiment illustrates the potential for rapid capillary LC to be used for high-throughput chemical experimentation with reduced time and material consumption. The cycle time for each injection was 7 s and the full run of 96 samples was completed within 13.5 min, with each sample corresponding to ˜8.3 s because of the combined programmed cycle time and delay caused by fluid pause during valve actuation. The screen was achieved at <50 μL/min mobile phase flow rate so that each sample consumed <6 μL solvent to analyze. In principle the system is also flexible, allowing different columns or detectors depending upon the application.

### Aspects

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### Aspects

Aspect 1. A method for introduction of a sample into a liquid chromatography column comprising an injection valve comprising a sample inlet, a sample outlet, a waste outlet, a first subset of fluidly coupled ports fluidly coupled by a sample loop, and a second set of fluidly coupled ports, comprising:
providing a sample array comprising a plurality of sample plugs and a plurality of segmenting fluid plugs arranged such that adjacent ones of the plurality of sample plugs being separated by a segmenting fluid plug, wherein each sample plug comprises a discrete volume of a sample and each segmenting fluid plug comprises a discrete volume of a segmenting fluid, the segmenting fluid and the sample being immiscible;
actuating the injection valve to a first position, wherein in the first position a port of the first subset of fluidly coupled ports positioned at an inlet of the sample loop is fluidly coupled to the sample inlet and a port of the first subset of fluidly coupled ports positioned at an outlet of the sample loop is fluidly coupled to waste outlet;
flowing a first sample plug into the sample loop while the injection valve is in the first position until a portion of the first sample plug flows out of the waste outlet indicating the sample loop is filled,
actuating the injection value to a second position after the sample loop is filled, wherein in the second position:
   the port of the first subset of ports at the outlet of the sample loop is fluidly coupled to the sample outlet, and
   the second subset of ports is arranged to fluidly couple the sample inlet and the waste outlet
flowing the first sample plug contained in the sample loop into the liquid chromatography column through the sample outlet while the injection valve is in the second position;
flowing a first segmenting fluid plug through the sample inlet and out the waste outlet while the injection valve is in the second position; and
repeating actuating of the injection valve to the first position, flowing of a sample plug into the sample loop, actuating of the injection valve to the second position, flowing of a sample plug into the liquid chromatography column through the sample outlet, and flowing of the segmenting fluid to waste outlet for each subsequent sample plug and segmenting fluid plug.

Aspect 2. The method of aspect 1, wherein providing the sample array comprises prefilling a tube with the sample array and connecting the filled tube to the injection valve.

Aspect 3. The method of aspect 1, wherein providing the sample array comprises alternatingly disposing a sampling tube in containers comprising sample and segmenting fluid and drawing a sample plug into the sampling tube and through the sample inlet while the injection valve is in the first position and drawing a segmenting fluid plug into the sampling tube and through the sample inlet while the injection valve is in the second position.

Aspect 4. The method of any one of the preceding aspects, wherein the segmenting fluid is a gas or an oil.

Aspect 5. The method of aspect 4, wherein the gas is an inert gas.

Aspect 6. The method of aspect 4 wherein the gas is air.

Aspect 7. The method of aspect 4, wherein the oil is a fluorinated oil.

Aspect 8. The method of aspect 5, wherein the fluorinated oil is perfluorodecalin.

Aspect 9. The method of any one of the preceding aspects, wherein the liquid chromatography column is part of an HPLC machine.

Aspect 10. The method of any one of aspects 1 to 9, wherein the liquid chromatography column is a capillary liquid chromatography column.

Aspect 11. The method of any one of the preceding aspects, wherein the sample array further comprises a plurality of washing plugs arranged between adjacent ones of the sample plug and the segmenting fluid plug, and upstream of the sample plug, such that the washing plug flows through the sample loop when the injection valve is in the first position before the sample plug flows into the sample loop.

Aspect 12. The method of aspect 11, wherein the washing plug comprise acetonitrile, methanol, and/or isopropanol.

Aspect 13. The method of aspect 11 or 12, wherein the washing plug has a volume of about 10 nL to 100 nL.

Aspect 14. The method of any one of the preceding aspects, wherein the sample loop has a volume of about 1 nL to about 25 μL.

Aspect 15. The method of any one of the preceding aspects, wherein the injection valve is a 4 port injection valve, the first subset of fluidly coupled ports comprising two fluidly coupled ports and the second subset of fluidly coupled ports comprising two fluidly coupled ports.

Aspect 16. The method of any one of aspects 1 to 15, wherein the injection valve is a 6 port injection valve, the first subset of fluidly coupled ports comprising 4 ports fluidly coupled by the sample loop, and the second subset of fluidly coupled ports comprising 2 ports.

Aspect 17. The method of any one of the preceding aspects, wherein the injection valve further comprising a mobile phase inlet, wherein in the first position, the second subset of fluidly coupled ports fluidly couples the mobile phase inlet to the sample outlet and in the second position, the port at the sample loop inlet is fluidly coupled to the mobile phase inlet, and flowing of the sample plug contained in the sample loop comprising flowing mobile phase through the mobile phase inlet to push the sample plug through the sample loop through the sample outlet and into the liquid chromatography column.

Aspect 18. The method of any one of the preceding aspects, wherein each one of the plurality of sample plugs and/or the segmenting plugs has a volume at least 1.5 to at least 10 times the volume of the sample loop.

Aspect 19. The method of any one of the preceding aspects, wherein repeating actuating of the injection valve to the first position, flowing of the sample plug into the sample loop, actuating of the injection valve to the second position, flowing of the sample plug into the liquid chromatography column through the sample outlet, and flowing of the segmenting fluid to waste outlet for each subsequent sample plug and segmenting fluid plug is controlled by a controller, wherein the controller:
receives a signal from at least one camera focused on at least the sample inlet, wherein the signal is indicative of presence of a sample plug or segmenting fluid plug in the sample inlet, and
controls a valve controller electronically coupled to the injection valve to actuate the injection valve between the first and second positions, wherein the injection valve is actuated to the first position when the signal from the camera indicates the sample plug is present in the sample inlet and to the second position when the signal from the camera indicates the segmenting fluid plug is present in the sample inlet.

Aspect 20. The method of aspect 19, wherein the signal is generated by:
obtaining images of the sample inlet with the camera, wherein the sample plug present in the sample inlet is distinguishable from the segmenting fluid plug present in the sample inlet by a gray value in the images;
for each image, measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value,
for each image, comparing the image with a previously taken image to detect if the phase of the image has changed relative to the previously taken image,
generating a signal for actuating the injection valve to the first position, when a phase change is detected from the segmenting fluid phase in the previously image to the sample fluid phase, and
generating a signal for actuating the injection valve to a second position when a phase change is detected from the sample fluid phase in the previous image to the segmenting fluid phase is detected.

Aspect 21. The method of aspect 19, further comprising:
calculating an arrival time of each the plurality of sample plugs and segmenting fluid plugs by:
   obtaining images of first and second regions of sample inlet while each of the plurality of sample plugs and segmenting fluid plugs is flowed through the sample inlet, wherein the first region is immediately upstream of the opaque region, and the second region is at least a selected distance upstream of the first region,
   measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value;
   calculating an arrival time for each of the plurality of sample plugs and plurality of segmenting fluid plugs, comprising:
      determining whether a phase of the sample inlet at the second region is a segmenting fluid plug phase or a sample plug phase to thereby determine whether the calculated arrival time is for a sample plug or a segmenting fluid plug;
      measuring a time of arrival of a head of the sample plug or segmenting fluid plug in each image at the second region, wherein the head of the sample plug or segmenting fluid plug is determined by detecting an interface between the sample plug phase and a segmenting plug phase in the image at the second region;
      measuring a time of arrive of the head of the sample plug or the segmenting fluid plug at the first region, wherein the head of the sample plug or the segmenting fluid plug is determined by detecting the interface between the sample plug phase and the segmenting plug phase at the first region;
      determining a difference of arrival time of the head of the sample plug or the segmenting fluid plug between the second region to the first region;
      calculating a velocity of the sample plug and the segmenting fluid plug by dividing the distance between the first and second regions by the respective difference of arrival time; and
   calculating an arrival time of the sample plug or the segmenting fluid plug at the sample loop by dividing a length of the opaque region by the respective calculated velocity and adding the quotient to a current time to thereby give the arrival time of the sample plug or the segmenting fluid plug; and
generating an array of arrival times of each of the plurality sample plugs and the plurality of segmenting fluid plugs,
wherein generating the signal is generated by comparing a current time to the array of arrival times and generating a signal actuating the injection valve to a first, load position, when the current time is equal to an arrival time of a sample plug, and generating a signal for actuating the injection valve from the first position to the second, inject position when the current time is equal to an arrive time of a segmenting fluid plug.

Aspect 22. The method of aspect 19, wherein the signal is generated by:
obtaining images of the sample inlet and the waste outlet with the at least one camera,
detecting an interface in the images at the sample inlet and the waste outlet and determining whether the detected interface at the sample inlet and the waste outlet is convex or concave, wherein a signal is generated to actuate the injection valve to the second position when the detected interface is concave at the sample and convex at the waste outlet, and wherein the injection valve automatically actuates from the second position back to the first position have a set injection time sufficient for injecting the entire sample in the sample loop into the liquid chromatography machine.

Aspect 23. The method of any one of aspects 19 to 22, wherein the camera is a machine vision camera.

Aspect 24. The method of any one of aspects 19 to 23, wherein the camera is a CCTV camera.

Aspect 25. A method for regenerating a column from contamination with a segmenting oil, comprising:
contaminating a column with a segmenting oil, the segmenting oil contaminating the column being a fluorinated oil; and
flowing an organic solvent through the contaminated column to thereby regenerate the column.

Aspect 26. The method of aspect 25, wherein the organic solvent is acetonitrile.

Aspect 27. The method of aspect 25 or 26, wherein a volume of washing solvent is at least one column volume.

Aspect 28. A method for introduction of a sample into a liquid chromatography column comprising an injection valve comprising a sample inlet, a sample outlet, a waste outlet, a first subset of fluidically coupled ports fluidically coupled by a sample loop, a second set of fluidically coupled ports, and an opaque region defined by a connector fluidically coupling the sample inlet and the sample loop comprising:
flowing a sample array into the sample inlet, the sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible, and each of the plurality of sample plugs and the plurality of segmenting fluid plugs having a length in the sample inlet that is greater than a length of the opaque;
obtaining images of the sample inlet, wherein a sample plug present in the sample inlet is distinguishable from a segmenting fluid plug present in the inlet tubing by a gray value in the images;
for each image, measuring a gray value and comparing the gray value of the image to a sample plug threshold gray value and a segmenting fluid plug threshold gray value to determine presence of a sample phase or segmenting fluid phase in the image, wherein a phase in the image is a sample plug phase when the gray value of the image is lower than the sample plug threshold gray value and is a segmenting fluid phase when the gray value of the image is higher than the segmenting fluid threshold gray scale value;
for each image, comparing the image with a previously taken image to determine if a phase in the image has changed relative to the previously taken image;
actuating the injection valve to a first, load position, when a phase change from the segmenting fluid phase in the previously image to the sample fluid phase is detected, wherein in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet, and in the first position, a sample plug is flowed into the sample loop from the sample inlet and flows out of the waste outlet when the sample loop is filled with the sample plug;
actuating the injection valve to a second, inject, position when a phase change from the sample fluid phase in the previously image to the segmenting fluid phase is detected, wherein in the second position, the port of the first subset of ports at the outlet of the sample loop is fluidically coupled to the sample outlet, the second subset of ports is arranged to fluidically couple the sample inlet and the waste outlet, and the sample plug contained in the sample loop is flowed into the liquid chromatography column through the sample outlet while the injection valve is in the second position, and the segmenting fluid plug through the sample inlet and out the waste outlet while the injection valve is in the second position; and
repeating actuation of the injection valve between the first and second position when phase changes in the images are detected.

Aspect 29. A method for introduction of a sample into a liquid chromatography column comprising an injection valve comprising a sample inlet, a sample outlet, a waste outlet, a first subset of fluidically coupled ports fluidically coupled by a sample loop, a second set of fluidically coupled ports, an opaque region defined by a connector fluidically coupling the sample inlet and the sample loop, comprising:
flowing a sample array into the sample inlet, the sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible, and each of the plurality of sample plugs and the plurality of segmenting fluid plugs having a length in the sample inlet that is less than a length of the opaque;
   obtaining images of first and second regions of sample inlet while each of the plurality of sample plugs and segmenting fluid plugs is flowed through the sample inlet, wherein the first region is immediately upstream of the opaque region, and the second region is at least a selected distance upstream of the first region,
   determining a phase of each image by measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value;
   calculating an arrival time for each of the plurality of sample plugs and plurality of segmenting fluid plugs, comprising:
      determining whether a phase of the sample inlet at the second region is a segmenting fluid plug phase or a sample plug phase to thereby determine whether the calculated arrival time is for a sample plug or a segmenting fluid plug;
      measuring a time of arrival of a head of the sample plug or segmenting fluid plug in each image at the second region, wherein the head of the sample plug or segmenting fluid plug is determined by detecting an interface between the sample plug phase and a segmenting plug phase in the image at the second region;
      measuring a time of arrive of the head of the sample plug or the segmenting fluid plug at the first region, wherein the head of the sample plug or the segmenting fluid plug is determined by detecting the interface between the sample plug phase and the segmenting plug phase at the first region;
      determining a difference of arrival time of the head of the sample plug or the segmenting fluid plug between the second region to the first region;
      calculating a velocity of the sample plug and the segmenting fluid plug by dividing the distance between the first and second regions by the respective difference of arrival time; and
   calculating an arrival time of the sample plug or the segmenting fluid plug at the sample loop by dividing a length of the opaque region by the respective calculated velocity and adding the quotient to a current time to thereby give the arrival time of the sample plug or the segmenting fluid plug; and
   generating an array of arrival times of each of the plurality sample plugs and the plurality of segmenting fluid plugs;
   actuating the injection valve between the first, load position and the second, inject position by comparing a current time to the array of arrival times,
      wherein:
      the injection valve is actuated to the first, load position when the current time is equal to an arrival time of a sample plug; and
      the injection valve is actuated to the second, inject position when the current time is equal to an arrival time of a segmenting fluid plug,
      in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet, and in the first position, a sample plug is flowed into the sample loop from the sample inlet and flows out of the waste outlet when the sample loop is filled with the sample plug, and
   in the second position, the port of the first subset of ports at the outlet of the sample loop is fluidically coupled to the sample outlet, the second subset of ports is arranged to fluidically couple the sample inlet and the waste outlet, and the sample plug contained in the sample loop is flowed into the liquid chromatography column through the sample outlet while the injection valve is in the second position, and the segmenting fluid plug through the sample inlet and out the waste outlet while the injection valve is in the second position.

### REFERENCES

(1) Mennen, S. M.; Alhambra, C.; Allen, C. L.; Barberis, M.; Berritt, S.; Brandt, T. A.; Campbell, A. D.; Castañón, J.; Cherney, A. H.; Christensen, M.; et al. The Evolution of High-Throughput Experimentation in Pharmaceutical Development and Perspectives on the Future. Org. Process Res. Dev. 2019, 23 (6), 1213-1242. DOI: 10.1021/acs.oprd.9b00140.
(2) Blay, V.; Tolani, B.; Ho, S. P.; Arkin, M. R. High-Throughput Screening: Today's Biochemical and Cell-Based Approaches. Drug Discov. Today. 2020, 25 (10), 1807-1821. DOI: 10.1016/j.drudis.2020.07.024.
(3) Grainger, R.; Whibley, S. A Perspective on the Analytical Challenges Encountered in High-Throughput Experimentation. Org. Process Res. Dev. 2021, 25 (3), 354-364. DOI: 10.1021/acs.oprd.0c00463.
(4) Buitrago Santanilla, A.; Regalado, E. L.; Pereira, T.; Shevlin, M.; Bateman, K.; Campeau, L.-C.; Schneeweis, J.; Berritt, S.; Shi, Z.-C.; Nantermet, P.; et al. Nanomole-Scale High-Throughput Chemistry for the Synthesis of Complex Molecules. Science. 2015, 347 (6217), 49-53. DOI: 10.1126/science. 1259203.
(5) Taylor, C. J.; Pomberger, A.; Felton, K. C.; Grainger, R.; Barecka, M.; Chamberlain, T. W.; Bourne, R. A.; Johnson, C. N.; Lapkin, A. A. A Brief Introduction to Chemical Reaction Optimization. Chem. Rev. 2023, 123 (6), 3089-3126. DOI: 10.1021/acs.chemrev.2c00798.
(6) Shultz, C. S.; Krska, S. W. Unlocking the Potential of Asymmetric Hydrogenation at Merck. Acc. Chem. Res. 2007, 40 (12), 1320-1326. DOI: 10.1021/ar700141v.
(7) Huang, Z.; Tian, D.; Liu, Y.; Lin, Z.; Lyon, C. J.; Lai, W.; Fusco, D.; Drouin, A.; Yin, X.; Hu, T.; et al. Ultra-Sensitive and High-Throughput CRISPR-p Owered COVID-19 Diagnosis. Biosens. Bioelectron. 2020, 164, 112316. DOI: 10.1016/j.bios.2020.112316.
(8) Benítez-Mateos, A. I.; Roura Padrosa, D.; Paradisi, F. Multistep Enzyme Cascades as a Route towards Green and Sustainable Pharmaceutical Syntheses. Nat. Chem. 2022, 14 (5), 489-499. DOI: 10.1038/s41557-022-00931-2.
(9) Agresti, J. J.; Antipov, E.; Abate, A. R.; Ahn, K.; Rowat, A. C.; Baret, J.-C.; Marquez, M.; Klibanov, A. M.; Griffiths, A. D.; Weitz, D. A. Ultrahigh-Throughput Screening in Drop-Based Microfluidics for Directed Evolution. Proc. Natl. Acad. Sci. U.S.A. 2010, 107 (9), 4004-4009. DOI: 10.1073/pnas.0910781107.
(10) Stucki, A.; Vallapurackal, J.; Ward, T. R.; Dittrich, P. S. Droplet Microfluidics and Directed Evolution of Enzymes: An Intertwined Journey. Angew. Chem. Int. 2021, 60 (46), 24368-24387. DOI: 10.1002/anie.202016154.
(11) Baret, J.-C.; Miller, O. J.; Taly, V.; Ryckelynck, M.; El-Harrak, A.; Frenz, L.; Rick, C.; Samuels, M. L.; Hutchison, J. B.; Agresti, J. J.; et al. Fluorescence-Activated Droplet Sorting (FADS): Efficient Microfluidic Cell Sorting Based on Enzymatic Activity. Lab Chip. 2009, 9 (13), 1850-1858. DOI: 10.1039/B902504A.
(12) Vallejo, D.; Nikoomanzar, A.; Paegel, B. M.; Chaput, J. C. Fluorescence-Activated Droplet Sorting for Single-Cell Directed Evolution. ACS Synth. Biol. 2019, 8 (6), 1430-1440. DOI: 10.1021/acssynbio.9b00103.
(13) High-Throughput Mass Spectrometry in Drug Discovery, 1st ed.; Liu, C., Zhang, H., Eds.; Wiley, 2023. DOI: 10.1002/9781119678496.
(14) Zhang, H.; Liu, C.; Hua, W.; Ghislain, L. P.; Liu, J.; Aschenbrenner, L.; Noell, S.; Dirico, K. J.; Lanyon, L. F.; Steppan, C. M.; et al. Acoustic Ejection Mass Spectrometry for High-Throughput Analysis. Anal. Chem. 2021, 93 (31), 10850-10861. DOI: 10.1021/acs.analchem.1c01137.
(15) Seger, C.; Salzmann, L. After Another Decade: LC-MS/MS Became Routine in Clinical Diagnostics. Clin. Biochem. 2020, 82, 2-11. DOI: 10.1016/j.clinbiochem.2020.03.004.
(16) High Throughput Screening: Methods and Protocols; Janzen, W. P., Ed.; Methods in Molecular Biology; Springer New York: New York, NY, 2016; Vol. 1439. DOI: 10.1007/978-1-4939-3673-1.
(17) Clausse, V.; Fang, Y.; Tao, D.; Tagad, H. D.; Sun, H.; Wang, Y.; Karavadhi, S.; Lane, K.; Shi, Z.-D.; Vasalatiy, O.; et al. Discovery of Novel Small-Molecule Scaffolds for the Inhibition and Activation of WIP1 Phosphatase from a RapidFire Mass Spectrometry High-Throughput Screen. ACS Pharmacol. Transl. Sci. 2022, 5 (10), 993-1006. DOI: 10.1021/acsptsci.2c00147.
(18) Wu, H.-T.; Riggs, D. L.; Lyon, Y. A.; Julian, R. R. Statistical Framework for Identifying Differences in Similar Mass Spectra: Expanding Possibilities for Isomer Identification. Anal. Chem. 2023, 95 (17), 6996-7005. DOI: 10.1021/acs.analchem.3c00495.
(19) Young, R. S. E.; Flakelar, C. L.; Narreddula, V. R.; Jekimovs, L. J.; Menzel, J. P.; Poad, B. L. J.; Blanksby, S. J. Identification of Carbon-Carbon Double Bond Stereochemistry in Unsaturated Fatty Acids by Charge-Remote Fragmentation of Fixed-Charge Derivatives. Anal. Chem. 2022, 94 (46), 16180-16188. DOI: 10.1021/acs.analchem.2c03625.
(20) Zhang, X.; Julian, R. R. Radical Mediated Dissection of Oligosaccharides. Int. J. Mass Spectrom. 2014, 372, 22-28. DOI: 10.1016/j.ijms.2014.07.045.
(21) Bai, L.; Romanova, E. V.; Sweedler, J. V. Distinguishing Endogenous D-Amino Acid-Containing Neuropeptides in Individual Neurons Using Tandem Mass Spectrometry. Anal. Chem. 2011, 83 (7), 2794-2800. DOI: 10.1021/ac200142m.
(22) Ashline, D. J.; Lapadula, A. J.; Liu, Y.-H.; Lin, M.; Grace, M.; Pramanik, B.; Reinhold, V. N. Carbohydrate Structural Isomers Analyzed by Sequential Mass Spectrometry. Anal. Chem. 2007, 79 (10), 3830-3842. DOI: 10.1021/ac062383a.
(23) Adams, C. M.; Zubarev, R. A. Distinguishing and Quantifying Peptides and Proteins Containing D-Amino Acids by Tandem Mass Spectrometry. Anal. Chem. 2005, 77 (14), 4571-4580. DOI: 10.1021/ac0503963.
(24) Schneider, B. B.; Bedford, L.; Liu, C.; Duchoslav, E.; Kang, Y.; Purkayastha, S.; Stella, A.; Covey, T. R. Differential Mobility Spectrometry and Its Application to High-Throughput Analysis. In High-Throughput Mass Spectrometry in Drug Discovery; John Wiley & Sons, Ltd, 2023; pp 215-265. DOI: 10.1002/9781119678496.ch7.
(25) Butler, K. E.; Baker, E. S. A High-Throughput Ion Mobility Spectrometry-Mass Spectrometry Screening Method for Opioid Profiling. J. Am. Soc. Mass Spectrom. 2022, 33 (10), 1904-1913. DOI: 10.1021/jasms.2c00186.
(26) Butler, K. E.; Dodds, J. N.; Flick, T.; Campuzano, I. D. G.; Baker, E. S. High-Resolution Demultiplexing (HRdm) Ion Mobility Spectrometry-Mass Spectrometry for Aspartic and Isoaspartic Acid Determination and Screening. Anal. Chem. 2022, 94 (16), 6191-6199. DOI: 10.1021/acs.analchem. 1c05533.
(27) Deng, L.; Ibrahim, Y. M.; Baker, E. S.; Aly, N. A.; Hamid, A. M.; Zhang, X.; Zheng, X.; Garimella, S. V. B.; Webb, I. K.; Prost, S. A.; et al. Ion Mobility Separations of Isomers Based upon Long Path Length Structures for Lossless Ion Manipulations Combined with Mass Spectrometry. ChemistrySelect. 2016, 1 (10), 2396-2399. DOI: 10.1002/slct.201600460.
(28) Fenn, L. S.; McLean, J. A. Structural Resolution of Carbohydrate Positional and Structural Isomers Based on Gas-Phase Ion Mobility-Mass Spectrometry. Phys. Chem. Chem. Phys. 2011, 13 (6), 2196-2205. DOI: 10.1039/C0CP01414A.
(29) Dwivedi, P.; Bendiak, B.; Clowers, B. H.; Hill, H. H. Rapid Resolution of Carbohydrate Isomers by Electrospray Ionization Ambient Pressure Ion Mobility Spectrometry-Time-of-Flight Mass Spectrometry (ESI-APIMS-TOFMS). J. Am. Soc. Mass Spectrom. 2007, 18 (7), 1163-1175. DOI: 10.1016/j.jasms.2007.04.007.
(30) Zetzsche, L. E.; Yazarians, J. A.; Chakrabarty, S.; Hinze, M. E.; Murray, L. A. M.; Lukowski, A. L.; Joyce, L. A.; Narayan, A. R. H. Biocatalytic Oxidative Cross-Coupling Reactions for Biaryl Bond Formation. Nature. 2022, 603 (7899), 79-85. DOI: 10.1038/s41586-021-04365-7.
(31) Beccaria, M.; Cabooter, D. Current Developments in LC-MS for Pharmaceutical Analysis. Analyst. 2020, 145 (4), 1129-1157. DOI: 10.1039/C9AN02145K.
(32) Huffman, M. A.; Fryszkowska, A.; Alvizo, O.; Borra-Garske, M.; Campos, K. R.; Canada, K. A.; Devine, P. N.; Duan, D.; Forstater, J. H.; Grosser, S. T.; et al. Design of an in Vitro Biocatalytic Cascade for the Manufacture of Islatravir. Science. 2019, 366 (6470), 1255-1259. DOI: 10.1126/science.aay8484.
(33) Wahab, M. F.; Wimalasinghe, R. M.; Wang, Y.; Barhate, C. L.; Patel, D. C.; Armstrong, D. W. Salient Sub-Second Separations. Anal. Chem. 2016, 88 (17), 8821-8826. DOI: 10.1021/acs.analchem.6b02260.
(34) Patel, D. C.; Wahab, M. F.; Armstrong, D. W.; Breitbach, Z. S. Advances in High-Throughput and High-Efficiency Chiral Liquid Chromatographic Separations. J. Chromatogr. A. 2016, 1467, 2-18. DOI: 10.1016/j.chroma.2016.07.040.
(35) Patel, D. C.; Wahab, M. F.; O'Haver, T. C.; Armstrong, D. W. Separations at the Speed of Sensors. Anal. Chem. 2018, 90 (5), 3349-3356. DOI: 10.1021/acs.analchem.7b04944.
(36) Kaplitz, A. S.; Kresge, G. A.; Selover, B.; Horvat, L.; Franklin, E. G.; Godinho, J. M.; Grinias, K. M.; Foster, S. W.; Davis, J. J.; Grinias, J. P. High-Throughput and Ultrafast Liquid Chromatography. Anal. Chem. 2020, 92 (1), 67-84. DOI: 10.1021/acs.analchem.9b04713.
(37) Kresge, G. A.; Grosse, S.; Zimmer, A.; Grinias, K. M.; De Pra, M.; Wong, J. T.; Steiner, F.; Grinias, J. P. Strategies in Developing High-throughput Liquid Chromatography Protocols for Method Qualification of Pharmacopeial Monographs. J. Sep. Sci. 2020, 43 (15), 2964-2970. DOI: 10.1002/jssc.202000403.
(38) Potts, L. W.; Stoll, D. R.; Li, X.; Carr, P. W. The Impact of Sampling Time on Peak Capacity and Analysis Speed in On-Line Comprehensive Two-Dimensional Liquid Chromatography. J. Chromatogr. A. 2010, 1217 (36), 5700-5709. DOI: 10.1016/j.chroma.2010.07.009.
(39) Stoll, D. R.; Cohen, J. D.; Carr, P. W. Fast, Comprehensive Online Two-Dimensional High Performance Liquid Chromatography through the Use of High Temperature Ultra-Fast Gradient Elution Reversed-Phase Liquid Chromatography. J. Chromatogr. A. 2006, 1122 (1-2), 123-137. DOI: 10.1016/j.chroma.2006.04.058.
(40) Stoll, D. R.; Carr, P. W. Fast, Comprehensive Two-Dimensional HPLC Separation of Tryptic Peptides Based on High-Temperature HPLC. J. Am. Chem. Soc. 2005, 127 (14), 5034-5035. DOI: 10.1021/ja050145b.
(41) Schellinger, A. P.; Stoll, D. R.; Carr, P. W. High Speed Gradient Elution Reversed-Phase Liquid Chromatography. J. Chromatogr. A. 2005, 1064 (2), 143-156. DOI: 10.1016/j.chroma.2004.12.017.
(42) Welch, C. J.; Gong, X.; Schafer, W.; Pratt, E. C.; Brkovic, T.; Pirzada, Z.; Cuff, J. F.; Kosjek, B. MISER Chromatography (Multiple Injections in a Single Experimental Run): The Chromatogram Is the Graph. Tetrahedron: Asymmetry. 2010, 21 (13), 1674-1681. DOI: 10.1016/j.tetasy.2010.05.029.
(43) Zawatzky, K.; Barhate, C. L.; Regalado, E. L.; Mann, B. F.; Marshall, N.; Moore, J. C.; Welch, C. J. Overcoming “Speed Limits” in High Throughput Chromatographic Analysis. Journal of Chromatography A 2017, 1499, 211-216. DOI: 10.1016/j.chroma.2017.04.002.
(44) Welch, C. J. Are We Approaching a Speed Limit for the Chromatographic Separation of Enantiomers? ACS Cent. Sci. 2017, 3 (8), 823-829. DOI: 10.1021/acscentsci.7b00250.
(45) Welch, C. J. High Throughput Analysis Enables High Throughput Experimentation in Pharmaceutical Process Research. React. Chem. Eng. 2019, 4 (11), 1895-1911. DOI: 10.1039/C9RE00234K.
(46) Moragues, T.; Arguijo, D.; Beneyton, T.; Modavi, C.; Simutis, K.; Abate, A. R.; Baret, J.-C.; deMello, A. J.; Densmore, D.; Griffiths, A. D. Droplet-Based Microfluidics. Nat. Rev. Methods. Primers. 2023, 3 (1), 32. DOI: 10.1038/s43586-023-00212-3.
(47) Payne, E. M.; Holland-Moritz, D. A.; Sun, S.; Kennedy, R. T. High-Throughput Screening by Droplet Microfluidics: Perspective into Key Challenges and Future Prospects. Lab Chip 2020, 20 (13), 2247-2262. DOI: 10.1039/DOLC00347F.
(48) Wang, X.-L.; Zhu, Y.; Fang, Q. Coupling Liquid Chromatography/Mass Spectrometry Detection with Microfluidic Droplet Array for Label-Free Enzyme Inhibition Assay. Analyst. 2014, 139 (1), 191-197. DOI: 10.1039/C3AN01917A.
(49) Piendl, S. K.; Schonfelder, T.; Polack, M.; Weigelt, L.; Van Der Zwaag, T.; Teutenberg, T.; Beckert, E.; Belder, D. Integration of Segmented Microflow Chemistry and Online HPLC/MS Analysis on a Microfluidic Chip System Enabling Enantioselective Analyses at the Nanoliter Scale. Lab Chip. 2021, 21 (13), 2614-2624. DOI: 10.1039/D1LC00078K.
(50) Sun, S.; Kennedy, R. T. Droplet Electrospray Ionization Mass Spectrometry for High Throughput Screening for Enzyme Inhibitors. Anal. Chem. 2014, 86 (18), 9309-9314. DOI: 10.1021/ac502542z.
(51) Pei, J.; Li, Q.; Lee, M. S.; Valaskovic, G. A.; Kennedy, R. T. Analysis of Samples Stored as Individual Plugs in a Capillary by Electrospray Ionization Mass Spectrometry. Anal. Chem. 2009, 81 (15), 6558-6561. DOI: 10.1021/ac901172a.
(52) Wahab, M. F.; Roy, D.; Armstrong, D. W. The Theory and Practice of Ultrafast Liquid Chromatography: A Tutorial. Anal. Chim. Acta. 2021, 1151, 238170. DOI: 10.1016/j.aca.2020.12.045.
(53) Gritti, F.; Gilar, M. Impact of Frit Dispersion on Gradient Performance in High-Throughput Liquid Chromatography. J. Chromatogr. A. 2019, 1591, 110-119. DOI: 10.1016/j.chroma.2019.01.021.
(54) Stoll, D. Effect of Flow Rate on UV Detection in Liquid Chromatography. LCGC North Am. 2019, 37 (12), 846-850.
(55) Zeng, W.; Bateman, K. P. Quantitative LC-MS/MS. 1. Impact of Points across a Peak on the Accuracy and Precision of Peak Area Measurements. J. Am. Soc. Mass Spectrom. 2023, 34 (6), 1136-1144. DOI: 10.1021/jasms.3c00077.
Kresge, G. A., et al., Strategies in developing high-throughput liquid chromatography protocols for method qualification of pharmacopeial monographs. Journal of Separation Science, 2020. 43 (15): p. 2964-2970.
Patel, D. C., et al., Separations at the Speed of Sensors. Analytical Chemistry, 2018. 90 (5): p. 3349-3356.
James P. Grinias and Edward G. Franklin, Considerations for Sample Injection in High-Throughput Liquid Chromatography. Chromatography Today, 2021. 14 (1): p. 34-38.
Kresge, G. A., et al., Using Superficially Porous Particles and Ultrahigh Pressure Liquid Chromatography in Pharmacopeial Monograph Modernization of Common Analgesics. Chromatographia, 2019. 82 (1): p. 465-475.
Welch, C. J., et al., MISER chromatography (multiple injections in a single experimental run): the chromatogram is the graph. Tetrahedron-Asymmetry, 2010. 21 (13-14): p. 1674-1681.
Wahab, M. F., et al., Salient Sub-Second Separations. Analytical Chemistry, 2016. 88 (17): p. 8821-8826.
Hidetoshi Terada, Katsuaki Koterasawa, and Takayuki Kihara, Increased Analysis Throughput by Overlapped Injection Using the SIL-40 Series Autosampler. Technical Note, 2019. C190-E235.
Welch, C. J., Are We Approaching a Speed Limit for the Chromatographic Separation of Enantiomers? ACS Cent Sci, 2017. 3 (8): p. 823-829.
Handlovic, T. T., et al., Automated Regularized Deconvolution for Eliminating Extra-Column Effects in Fast High-Efficiency Separations. Anal Chem, 2023. 95 (29): p. 11028-11036.
Hellinghausen, G., M. F. Wahab, and D. W. Armstrong, Improving peak capacities over 100 in less than 60 seconds: operating above normal peak capacity limits with signal processing. Analytical and Bioanalytical Chemistry, 2020. 412 (8): p. 1925-1932.
Foster, S. W., et al., Portable capillary liquid chromatography for pharmaceutical and illicit drug analysis. J Sep Sci, 2020. 43 (9-10): p. 1623-1627.
Rohman, M. and J. Wingfield, High-Throughput Screening Using Mass Spectrometry within Drug Discovery. High Throughput Screening: Methods and Protocols, 3rd Edition, 2016. 1439: p. 47-63.
Tao, D. Y., et al., High-throughput protein modification quantitation analysis using intact protein MRM and its application on hENGase inhibitor screening. Talanta, 2021. 231.
Clausse, V., et al., Discovery of Novel Small-Molecule Scaffolds for the Inhibition and Activation of WIP1 Phosphatase from a RapidFire Mass Spectrometry High-Throughput Screen. Acs Pharmacology & Translational Science, 2022. 5 (10): p. 993-1006.
Rogeberg, M., et al., On-line solid phase extraction-liquid chromatography, with emphasis on modern bioanalysis and miniaturized systems. J Pharm Biomed Anal, 2014. 87: p. 120-9.
Viglino, L., et al., On-line solid phase extraction and liquid chromatography/tandem mass spectrometry to quantify pharmaceuticals, pesticides and some metabolites in wastewaters, drinking, and surface waters. Journal of Environmental Monitoring, 2008. 10 (4): p. 482-489.
Koreshkova, A. N., et al., Recent advances and applications of synthetic diamonds in solid-phase extraction and high-performance liquid chromatography. Journal of Chromatography A, 2021. 1640.
Samadifar, M., et al., Automated and semi-automated packed sorbent solid phase (micro) extraction methods for extraction of organic and inorganic pollutants. Journal of Chromatography A, 2023. 1706.
Ben Hsen, E. and L. Latrous, Magnetic Solid-Phase Extraction Based on Magnetite-Multiwalled Carbon Nanotubes of Non-Steroidal Anti-Inflammatories from Water Followed by LC-ESI-MS/MS. Journal of Chromatographic Science, 2023. 61 (2): p. 186-194.
Kim, D. H., et al., Analysis of hair and plasma samples for methotrexate (MTX) and metabolite using high-performance liquid chromatography triple quadrupole mass spectrometry (LC-MS/MS) detection. Journal of Mass Spectrometry, 2021. 56 (4).
Fisher, E. N., et al., Development and Validation of an LC-MS/MS Method for Simultaneous Determination of Short Peptide-Based Drugs in Human Blood Plasma. Molecules, 2022. 27 (22).
Clausse, V., et al., Physiologically relevant orthogonal assays for the discovery of small-molecule modulators of WIP1 phosphatase in high-throughput screens. Journal of Biological Chemistry, 2019. 294 (46): p. 17654-17668.
Piendl, S. K., et al., Integration of segmented microflow chemistry and online HPLC/MS analysis on a microfluidic chip system enabling enantioselective analyses at the nanoliter scale. Lab on a Chip, 2021. 21 (13): p. 2614-2624.
Mahjour, B., Y. Shen, and T. Cernak, Ultrahigh-Throughput Experimentation for Information-Rich Chemical Synthesis. Acc Chem Res, 2021. 54 (10): p. 2337-2346.
Mahjour, B., et al., Rapid planning and analysis of high-throughput experiment arrays for reaction discovery. Nat Commun, 2023. 14 (1): p. 3924.
Buitrago Santanilla, A., et al., Organic chemistry. Nanomole-scale high-throughput chemistry for the synthesis of complex molecules. Science, 2015. 347 (6217): p. 49-53.
Gesmundo, N. J., et al., Nanoscale synthesis and affinity ranking. Nature, 2018. 557 (7704): p. 228-232.
Perera, D., et al., A platform for automated nanomole-scale reaction screening and micromole-scale synthesis in flow. Science, 2018. 359 (6374): p. 429-434.
Agresti, J. J., et al., Ultrahigh-throughput screening in drop-based microfluidics for directed evolution (vol 170, pg 4004, 2010). Proceedings of the National Academy of Sciences of the United States of America, 2010. 107 (14): p. 6550-6550.
Lu, X., et al., High-Throughput Platform for Novel Reaction Discovery. Chemistry-a European Journal, 2022. 28 (50).
Zhu, L. J., Screening a Panel of Acid-producing Strains by Developing a High-throughput Method (vol 27, pg 784, 2022). Biotechnology and Bioprocess Engineering, 2022. 27 (6).
SHISHI LIN, et al., Mapping the dark space of chemical reactions with extended nanomole synthesis and MALDI-TOF MS. Science, 2018. 361 (6402): p. eaar6236.
Sun, A. C., et al., High-Throughput Optimization of Photochemical Reactions using Segmented-Flow Nanoelectrospray-Ionization Mass Spectrometry. Angew Chem Int Ed Engl, 2023. 62 (28): p. e202301664.
Sun, A. C., et al., A droplet microfluidic platform for high-throughput photochemical reaction discovery. Nature Communications, 2020. 11 (1).
Kallitsakis, M. G., et al., Mechanistic Studies on the Michael Addition of Amines and Hydrazines To Nitrostyrenes: Nitroalkane Elimination via a Retro-aza-Henry-Type Process. Journal of Organic Chemistry, 2018. 83 (3): p. 1176-1184.
Desmet, G. and K. Broeckhoven, Extra-column band broadening effects in contemporary liquid chromatography: Causes and solutions. Trac-Trends in Analytical Chemistry, 2019. 119.
Shiraishi, H., et al., Regioselective synthesis of alkylpyrroles from imines and nitroalkenes by lanthanide compounds. Tetrahedron, 1999. 55 (49): p. 13957-13964.
Zlyael-Halimehjani, A. and M. R. Saidi, Synthesis of aza-Henry products and enamines in water by Michael addition of amines or thiols to activated unsaturated compounds. Tetrahedron Letters, 2008. 49 (7): p. 1244-1248.
Barbero, M., S. Cadamuro, and S. Dughera,-Benzenedisulfonimide as a Reusable Bronsted Acid Catalyst for Hetero-Michael Reactions. Synthetic Communications, 2013. 43 (5): p. 758-767.

What is claimed is:

1. A method for introduction of a sample into a liquid chromatography column comprising an injection valve comprising a sample inlet, a sample outlet, a waste outlet, a first subset of fluidically coupled ports fluidically coupled by a sample loop, and a second set of fluidically coupled ports, comprising:
providing a sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible;
actuating the injection valve to a first position, wherein in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet;
flowing a first sample plug into the sample loop while the injection valve is in the first position until a portion of the first sample plug flows out of the waste outlet indicating the sample loop is filled,
actuating the injection valve to a second position after the sample loop is filled, wherein in the second position:
the port of the first subset of ports at the outlet of the sample loop is fluidically coupled to the sample outlet, and
the second subset of ports is arranged to fluidically couple the sample inlet and the waste outlet,
flowing the first sample plug contained in the sample loop into the liquid chromatography column through the sample outlet while the injection valve is in the second position;
flowing a first segmenting fluid plug through the sample inlet and out the waste outlet while the injection valve is in the second position; and
repeating actuating of the injection valve to the first position, flowing of a sample plug into the sample loop, actuating of the injection valve to the second position, flowing of a sample plug into the liquid chromatography column through the sample outlet, and flowing of the segmenting fluid to waste outlet for each subsequent sample plug and segmenting fluid plug.

2. The method of claim 1, wherein providing the sample array comprises prefilling a tube with the sample array and connecting the filled tube to the injection valve.

3. The method of claim 1, wherein providing the sample array comprises alternatingly disposing a sampling tube in containers comprising sample and segmenting fluid and drawing a sample plug into the sampling tube and through the sample inlet while the injection valve is in the first position and drawing a segmenting fluid plug into the sampling tube and through the sample inlet while the injection valve is in the second position.

4. The method of claim 1, wherein the segmenting fluid is a gas or an oil.

5. The method of claim 1, wherein the liquid chromatography column is part of an HPLC machine or a capillary liquid chromatography column.

6. The method of claim 1, wherein the sample array further comprises a plurality of washing plugs arranged between adjacent ones of the sample plug and the segmenting fluid plug, and upstream of the sample plug, such that the washing plug flows through the sample loop when the injection valve is in the first position before the sample plug flows into the sample loop.

7. The method of claim 6, wherein the washing plug comprise acetonitrile, methanol, and/or isopropanol and/or a volume of about 10 nL to about 100 nL.

8. The method of claim 1, wherein the sample loop has a volume of about 1 nL to about 25 UL.

9. The method of claim 1, wherein the injection valve is a 4 port injection valve, the first subset of fluidically coupled ports comprising two fluidically coupled ports and the second subset of fluidically coupled ports comprising two fluidically coupled ports; or
wherein the injection valve is a 6 port injection valve, the first subset of fluidically coupled ports comprising 4 ports fluidically coupled by the sample loop, and the second subset of fluidically coupled ports comprising 2 ports.

10. The method of claim 1, wherein the injection valve further comprising a mobile phase inlet, wherein in the first position, the second subset of fluidically coupled ports fluidically couples the mobile phase inlet to the sample outlet and in the second position, the port at the sample loop inlet is fluidically coupled to the mobile phase inlet, and flowing of the sample plug contained in the sample loop comprising flowing mobile phase through the mobile phase inlet to push the sample plug through the sample loop through the sample outlet and into the liquid chromatography column.

11. The method of claim 1, wherein each one of the plurality of sample plugs and/or the segmenting plugs has a volume at least 1.5 to at least 10 times the volume of the sample loop.

12. The method of claim 1, wherein repeating actuating of the injection valve to the first position, flowing of the sample plug into the sample loop, actuating of the injection valve to the second position, flowing of the sample plug into the liquid chromatography column through the sample outlet, and flowing of the segmenting fluid to waste outlet for each subsequent sample plug and segmenting fluid plug is controlled by a controller, wherein the controller:
receives a signal from at least one camera focused on at least the sample inlet, wherein the signal is indicative of presence of a sample plug or segmenting fluid plug in the sample inlet, and
controls a valve controller electronically coupled to the injection valve to actuate the injection valve between the first and second positions, wherein the injection valve is actuated to the first position when the signal from the camera indicates the sample plug is present in the sample inlet and to the second position when the signal from the camera indicates the segmenting fluid plug is present in the sample inlet.

13. The method of claim 12, wherein the signal is generated by:
obtaining images of a region of the sample inlet with the camera, wherein the sample plug present in the sample inlet is distinguishable from the segmenting fluid plug present in the sample inlet by a gray value in the images;
for each image, measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value,
for each image, comparing the image with a previously taken image to detect if the phase of the image has changed relative to the previously taken image,
generating a signal for actuating the injection valve to the first position, when a phase change is detected from the segmenting fluid phase in the previously image to the sample fluid phase, and
generating a signal for actuating the injection valve to a second position when a phase change is detected from the sample fluid phase in the previous image to the segmenting fluid phase is detected.

14. The method of claim 12, further comprising:
calculating an arrival time of each the plurality of sample plugs and segmenting fluid plugs by:
obtaining images of first and second regions of sample inlet while each of the plurality of sample plugs and segmenting fluid plugs is flowed through the sample inlet, wherein the first region is immediately upstream of the opaque region, and the second region is at least a selected distance upstream of the first region,
measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value;
calculating an arrival time for each of the plurality of sample plugs and plurality of segmenting fluid plugs, comprising:
determining whether a phase of the sample inlet at the second region is a segmenting fluid plug phase or a sample plug phase to thereby determine whether the calculated arrival time is for a sample plug or a segmenting fluid plug;
measuring a time of arrival of a head of the sample plug or segmenting fluid plug in each image at the second region, wherein the head of the sample plug or segmenting fluid plug is determined by detecting an interface between the sample plug phase and a segmenting plug phase in the image at the second region;
measuring a time of arrive of the head of the sample plug or the segmenting fluid plug at the first region, wherein the head of the sample plug or the segmenting fluid plug is determined by detecting the interface between the sample plug phase and the segmenting plug phase at the first region;
determining a difference of arrival time of the head of the sample plug or the segmenting fluid plug between the second region to the first region;
calculating a velocity of the sample plug and the segmenting fluid plug by dividing the distance between the first and second regions by the respective difference of arrival time; and
calculating an arrival time of the sample plug or the segmenting fluid plug at the sample loop by dividing a length of the opaque region by the respective calculated velocity and adding the quotient to a current time to thereby give the arrival time of the sample plug or the segmenting fluid plug; and
generating an array of arrival times of each of the plurality sample plugs and the plurality of segmenting fluid plugs,
wherein generating the signal is generated by comparing a current time to the array of arrival times and generating a signal actuating the injection valve to a first, load position, when the current time is equal to an arrival time of a sample plug, and generating a signal for actuating the injection valve from the first position to the second, inject position when the current time is equal to an arrive time of a segmenting fluid plug.

15. The method of claim 12, wherein the signal is generated by:
obtaining images of the sample inlet and the waste outlet with the at least one camera,
detecting an interface in the images at the sample inlet and the waste outlet and determining whether the detected interface at the sample inlet and the waste outlet is convex or concave, wherein a signal is generated to actuate the injection valve to the second position when the detected interface is concave at the sample and convex at the waste outlet, and wherein the injection valve automatically actuates from the second position back to the first position have a set injection time sufficient for injecting the entire sample in the sample loop into the liquid chromatography machine.

16. A method for regenerating a column from contamination with a segmenting oil, comprising:
contaminating a column with a segmenting oil, the segmenting oil contaminating the column being a fluorinated oil; and
flowing an organic solvent through the contaminated column to thereby regenerate the column.

17. The method of claim 16, wherein the organic solvent is acetonitrile.

18. The method of claim 16, wherein a volume of washing solvent is at least one column volume.

19. A method for introduction of a sample into a liquid chromatography column comprising an injection valve comprising a sample inlet, a sample outlet, a waste outlet, a first subset of fluidically coupled ports fluidically coupled by a sample loop, a second set of fluidically coupled ports, and an opaque region defined by a connector fluidically coupling the sample inlet and the sample loop comprising:
flowing a sample array into the sample inlet, the sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible, and each of the plurality of sample plugs and the plurality of segmenting fluid plugs having a length in the sample inlet that is greater than a length of the opaque;
obtaining images of a region of the sample inlet, wherein a sample plug present in the sample inlet at the region is distinguishable from a segmenting fluid plug present in the inlet tubing by a gray value in the images;
for each image, measuring a gray value and comparing the gray value of the image to a sample plug threshold gray value and a segmenting fluid plug threshold gray value to determine presence of a sample phase or segmenting fluid phase in the image, wherein a phase in the image is a sample plug phase when the gray value of the image is lower than the sample plug threshold gray value and is a segmenting fluid phase when the gray value of the image is higher than the segmenting fluid threshold gray scale value;
for each image, comparing the image with a previously taken image to determine if a phase in the image has changed relative to the previously taken image;
actuating the injection valve to a first, load position, when a phase change from the segmenting fluid phase in the previously image to the sample fluid phase is detected, wherein in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet, and in the first position, a sample plug is flowed into the sample loop from the sample inlet and flows out of the waste outlet when the sample loop is filled with the sample plug;
actuating the injection valve to a second, inject, position when a phase change from the sample fluid phase in the previously image to the segmenting fluid phase is detected, wherein in the second position, the port of the first subset of ports at the outlet of the sample loop is fluidically coupled to the sample outlet, the second subset of ports is arranged to fluidically couple the sample inlet and the waste outlet, and the sample plug contained in the sample loop is flowed into the liquid chromatography column through the sample outlet while the injection valve is in the second position, and the segmenting fluid plug through the sample inlet and out the waste outlet while the injection valve is in the second position; and
repeating actuation of the injection valve between the first and second position when phase changes in the images are detected.

20. A method for introduction of a sample into a liquid chromatography column comprising an injection valve comprising a sample inlet, a sample outlet, a waste outlet, a first subset of fluidically coupled ports fluidically coupled by a sample loop, a second set of fluidically coupled ports, an opaque region defined by a connector fluidically coupling the sample inlet and the sample loop, comprising:
flowing a sample array into the sample inlet, the sample array comprising a plurality of sample plugs and a plurality of segmenting fluid plugs arranged such that adjacent ones of the plurality of sample plugs are separated by a segmenting fluid plug, wherein each sample plug comprises a discrete volume of a sample and each segmenting fluid plug comprises a discrete volume of a segmenting fluid, the segmenting fluid and the sample being immiscible, and each of the plurality of sample plugs and the plurality of segmenting fluid plugs having a length in the sample inlet that is less than a length of the opaque;
obtaining images of first and second regions of sample inlet while each of the plurality of sample plugs and segmenting fluid plugs is flowed through the sample inlet, wherein the first region is immediately upstream of the opaque region, and the second region is at least a selected distance upstream of the first region,
determining a phase of each image by measuring a gray value and comparing the gray value of the image to a sample plug threshold gray value and a segmenting fluid plug threshold gray value to determine presence of a sample phase or segmenting fluid phase in the image, wherein the phase in the image is the sample plug phase when the gray value of the image is lower than the sample plug threshold gray value and is the segmenting fluid phase when the gray value of the image is higher than the segmenting fluid threshold gray scale value;
calculating an arrival time for each of the plurality of sample plugs and plurality of segmenting fluid plugs, comprising:
determining whether a phase of the sample inlet at the second region is a segmenting fluid plug phase or a sample plug phase to thereby determine whether the calculated arrival time is for a sample plug or a segmenting fluid plug;
measuring a time of arrival of a head of the sample plug or segmenting fluid plug in each image at the second region, wherein the head of the sample plug or segmenting fluid plug is determined by detecting an interface between the sample plug phase and a segmenting plug phase in the image at the second region;
measuring a time of arrive of the head of the sample plug or the segmenting fluid plug at the first region, wherein the head of the sample plug or the segmenting fluid plug is determined by detecting the interface between the sample plug phase and the segmenting plug phase at the first region;
determining a difference of arrival time of the head of the sample plug or the segmenting fluid plug between the second region to the first region;
calculating a velocity of the sample plug and the segmenting fluid plug by dividing the distance between the first and second regions by the respective difference of arrival time; and
calculating an arrival time of the sample plug or the segmenting fluid plug at the sample loop by dividing a length of the opaque region by the respective calculated velocity and adding the quotient to a current time to thereby give the arrival time of the sample plug or the segmenting fluid plug; and
generating an array of arrival times of each of the plurality sample plugs and the plurality of segmenting fluid plugs;
actuating the injection valve between the first, load position and the second, inject position by comparing a current time to the array of arrival times,
wherein:
the injection valve is actuated to the first, load position when the current time is equal to an arrival time of a sample plug; and
the injection valve is actuated to the second, inject position when the current time is equal to an arrival time of a segmenting fluid plug,
in the first position a port of the first subset of fluidically coupled ports positioned at an inlet of the sample loop is fluidically coupled to the sample inlet and a port of the first subset of fluidically coupled ports positioned at an outlet of the sample loop is fluidically coupled to waste outlet, and in the first position, a sample plug is flowed into the sample loop from the sample inlet and flows out of the waste outlet when the sample loop is filled with the sample plug, and
in the second position, the port of the first subset of ports at the outlet of the sample loop is fluidically coupled to the sample outlet, the second subset of ports is arranged to fluidically couple the sample inlet and the waste outlet, and the sample plug contained in the sample loop is flowed into the liquid chromatography column through the sample outlet while the injection valve is in the second position, and the segmenting fluid plug through the sample inlet and out the waste outlet while the injection valve is in the second position.
